(19) United States
(12) Patent Application Publication
(10) Pub. No.: US 2007/0027718 A1
(43) Pub. Date: Feb. 1, 2007

(54) Health care service transaction approval system and method

(75) Inventors: Kari Ann Amerantes, Mansfield, MA (US); Mary J. Ammer, Roseville, MN (US); Deborah J. Belcher, Hinesburg, VT (US); Christine Hagar, Braintree, MA (US); Ian Mercer, Fairfax, VT (US); Dawn Nee, Walpole, MA (US)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: General Electric Company, Schenectady, NY (US)

(21) Appl. No.: 11/474,748

(22) Filed: Jun. 26, 2006

Related U.S. Application Data
(60) Provisional application No. 60/704,162, filed on Jul. 29, 2005.

(51) Int. Cl. G06F 19/00; G06Q 99/00

(52) U.S. Cl. 705/3; 705/75

(57) ABSTRACT

A method and system for processing health care service transaction approval (STA) requests, such as referral requests, a pre-certification requests or service authorization requests. The method automates the processes of sending electronic STA requests to payers, receiving electronic replies to the STA requests from the payers and presenting information contained in the STA replies to users in a readily discernable manner. The system is configured for providing the various functions of the method.

### RELATED APPLICATION DATA

This application claims the benefit of priority of U.S. Provisional Patent Application Ser. No. 60/704,162, filed Jul. 29, 2005, and titled “Health Care Service Transaction Approval System And Method,” that is incorporated by reference herein in its entirety.

### FIELD OF THE INVENTION

The present invention generally relates to the field of information systems. In particular, the present invention is directed to a health care service transaction approval system and method.

### BACKGROUND OF THE INVENTION

In the United States and other countries, the majority of the population have at least a portion of their health care costs paid by institutional payers, e.g., insurance companies, health care maintenance organizations (HMOs), privately insured groups and government agencies, among others. Oftentimes, institutional payers allow members to select a primary care physician who typically practices general medicine. Some payers, e.g., managed care institutions such as HMOs, require each of their members to select a primary care physician from among a predetermined set of approved physicians that have agreed to participate in a managed care plan. Other payers, e.g., traditional health care insurers, permit their insureds to select a primary care physician at large from a local, state or other regional general practitioner population.

While an institutional payer patient may generally visit or otherwise utilize their primary care physician at will without prior approval of the payer, payers often require the patient to seek their payer's approval to receive other health care services. Examples of such other services include services provided by specialist physicians, surgeons, ambulance transporters, physical therapists, chiropractors, home care providers, and medical equipment providers, e.g., oxygen therapy equipment provides, among many others. If a patient receives services requiring approval without first obtaining payer approval, the payer may not cover the services received.

Conventionally, there are several categories of health care service transactions for which payers may require approval. For example, payers may require that referrals be pre-approved prior to a patient consuming the health care services resulting from the referral. Generally, a referral is a health care service transaction in which one health care provider, e.g., a primary care physician, refers a patient to another healthcare provider, e.g., a specialist physician. Another health care service transaction for which payers may require approval is a “pre-certification,” in which a payer wants to know relatively general information about the type of health care service proposed to be received by the insured so as to verify that the insured is indeed covered under the payer's policy. Yet another health care service transaction for which payers may require approval is an “authorization.” Authorization typically involves a payer reviewing detailed clinical information about the patient in order to determine the medical necessity of the proposed service and may also include a determination of whether or not a better course of treatment exists that may be less expensive or less invasive. It is recognized: that referrals, pre-certifications and authorizations may not be the only types of health care service transactions for which payers may require approval; that this terminology may not be uniform throughout the industry; and that these terms, particularly, “pre-certification” and “authorization,” are sometime used interchangeably.

Present state-of-the-art processes for health care providers to obtain approvals for health care service transactions are largely manual processes that require health care workers to place telephone calls to payers and/or access secure payer Websites in order to process health care service transaction requests. For example, the present workflow for processing a primary care physician to specialist physician referral request using present generation health care enterprise software, such as the FLOWCAST® software licensed by GE Healthcare of Barrington, Ill., may proceed as follows. After the patient consults with their primary care physician and the physician recommends that the patient see a specialist, that physician instructs office staff to update the patient's records in the FLOWCAST® software's database so as to note that a referral has been made and to request the patient's payer to approve the referral. The office staff will then update the patient's records using a “referrals” graphical user interface (GUI) that allows the staff to input information regarding the referral, e.g., the name of the specialist to which the referral is made, the type of the referral, e.g., inpatient or outpatient, the reason for the referral, the payer's name and/or code, and the status of the referral, e.g., approved, denied or pending, among other information.

After the office staff updates the patient's medical records with the referral information, the FLOWCAST® software then places a work task on a “referrals” worklist for subsequent processing of the referral. At this point, there may be a number of referrals tasks already on the worklist, and more may be added subsequently. After the referral has been posted to the referrals worklist, a worker in the primary care physician's office that is assigned to processing referrals will process the referral tasks then on the worklist, including the specialist referral described above. When the worker processes the exemplary specialist referral, they typically will either call the payer or access the payers secure Website in order to request the payer to approve the referral. The approval may be made immediately, e.g., while the worker remains on the phone, or may be made at a later time. If the approval (or denial, incomplete or other non-approval) is immediate, the worker will note the approval or non-approval in the patient's medical record via the referrals GUI. If the approval or non-approval is not immediate, the worker may move down the worklist to another referral work task while waiting for the payer to respond. Once the payer responds, the worker will return to that referral work task (which remains on the worklist as not being resolved) in order to update the status of the referral, e.g., approved, denied, incomplete or other status. In either the immediate response or delayed response mode, if the specialist referral is not approved, the referral will remain on the referrals worklist until all outstanding issues have been resolved.

The foregoing example illustrates perhaps the most non-complex type of health care service transaction request process performed. In this example, the payer does not need to review any additional information, e.g., clinical information such as diagnostic reports, clinical notes, radiological images, etc. Regardless, the process requires a relatively large amount of human interaction and involvement. Even if the referral request were approved immediately, the worker would have to manually key into the referrals GUI approval information, such as the approved status, payer approval reference number, effective period of the approval, number of visits to the specialist authorized, etc.

From there, the level of human interaction and involvement only increase. For example, if the specialist referral had been denied or otherwise not approved, the worker would not only have to update the status as being not approved and follow up as necessary and re-contact the payer to resolve the non-approval. The level of human interaction and involvement increases greatly when a referral or other health care service transaction requires the payer to review clinical information. In this case, in addition to the involvement noted above, the task worker must also gather the necessary information and send it to the payer. It can be readily seen that the conventional process of seeking payer approval of health care service transactions is highly labor intensive. What is needed is a health care service transaction approval system and method that reduces the level of human involvement in seeking and obtaining transaction approval and, correspondingly, the cost of seeking and obtaining such approval.

### SUMMARY OF THE INVENTION

In one aspect, the present invention is directed to a method of processing a health care service transaction approval request. The method comprises a step of receiving and electronically storing request information required by a health care payer in order to adjudicate a health care service transaction approval request. An electronic data interchange (EDI) request is sent to the health care payer. The EDI request contains the request information. An EDI response to the EDI request is received. The EDI response containing at least one adjudication code. The at least one adjudication code is translated into plain text. A graphical display displays a graphical user interface containing said plain text.

In another aspect, the present invention is directed to a method of processing a health care service transaction approval request. The method comprises a step of presenting a graphical user interface to a user. The graphical user interface comprises a first input receiver operatively configured to indicate a selected health care service type of a predetermined set of health care service types and a second input receiver operatively configured to indicate a selected health care service reason of a predetermined set of health care service reasons. The selected health care service type is received via the first input receiver. The selected health care service reason is received via the second input receiver. A health care service form is selected to present to the user as a function of either the selected health care service type received or the selected health care service reason received or both of said selected health care service type received and said selected health care service reason received.

In a further aspect, the present invention is directed to a method of processing a health care service transaction approval request. The method comprises a step of presenting a graphical user interface to a user. The graphical user interface comprises an input receiver operatively configured to indicate a specific health care service transaction request status that is a member of a predetermined set of health care service transaction request statuses. The specific health care service transaction request status is received via said input receiver. Whether or not to send a health care service transaction approval request is determined as a function of said specific health care service transaction request status received.

In yet another aspect, the present invention is directed to a method of processing a health care service transaction approval request. The method comprises a step of presenting a graphical user interface to a user. The graphical user interface comprises a first input receiver operatively configured to indicate a specific health care service transaction request status that is a member of a predetermined set of health care service transaction request statuses. The specific health care service transaction request status is received via the first input receiver. A number of second input receivers to display to a user is determined as a function of the specific health care service transaction request received.

### BRIEF DESCRIPTION OF THE DRAWINGS

For the purpose of illustrating the invention, the drawings show a form of the invention that is presently preferred. However, it should be understood that the present invention is not limited to the precise arrangements and instrumentalities shown in the drawings, wherein:

FIG. 1 is a high-level diagram of workflow using an automated health care service transaction approval system of the present invention;

FIG. 2 is a high-level schematic diagram of an automated health care service transaction approval system of the present invention;

FIG. 3A is a screenshot of a homepage of the service transaction approval system of FIG. 2;

FIG. 3B is a screenshot of a Treatment form page of the service transaction approval system of FIG. 2;

FIG. 3C is a screenshot of a referral send confirmation pop-up window of the service transaction approval system of FIG. 2;

FIG. 3D is a screenshot of an automatic reply waiting page of the service transaction approval system of FIG. 2;

FIG. 3E is a screenshot of an automatic reply Results page of the service transaction approval system of FIG. 2;

FIG. 3F is a screenshot of a EDI Transaction History page of the service transaction approval system of FIG. 2;

FIG. 3G is a screenshot of an Audit Trail page of the service transaction approval system of FIG. 2;

FIG. 3H is a screenshot of an Accident Service form page of the service transaction approval system of FIG. 2;

FIG. 3I is a screenshot of a General Service form page of the service transaction approval system of FIG. 2;

FIG. 3J is a screenshot of an Ambulance Transport Service form page of the service transaction approval system of FIG. 2;

FIG. 3K is a screenshot of an Inpatient Service form page of the service transaction approval system of FIG. 2;

FIG. 3L is a screenshot of a Maternity Service form page of the service transaction approval system of FIG. 2;

FIG. 3M is a screenshot of a Spinal Manipulation Service form page of the service transaction approval system of FIG. 2;

FIG. 3N is a screenshot of an Oxygen Therapy Service form page of the service transaction approval system of FIG. 2;

FIGS. 4A-4C show a flow diagram for a method of automatically processing service transaction approval request and reply that may be implemented in the service transaction approval system of FIG. 2; and

FIG. 5 is a high-level schematic diagram of a computer system containing a service transaction approval system of the present invention.

### DETAILED DESCRIPTION

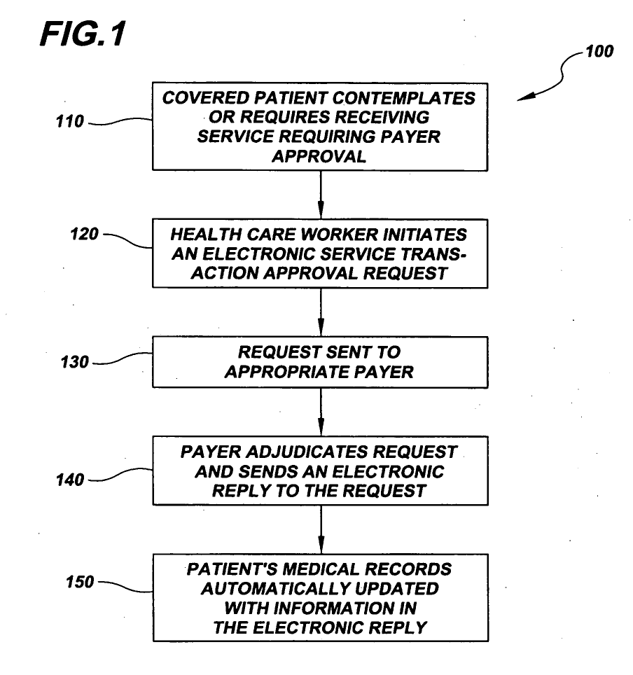

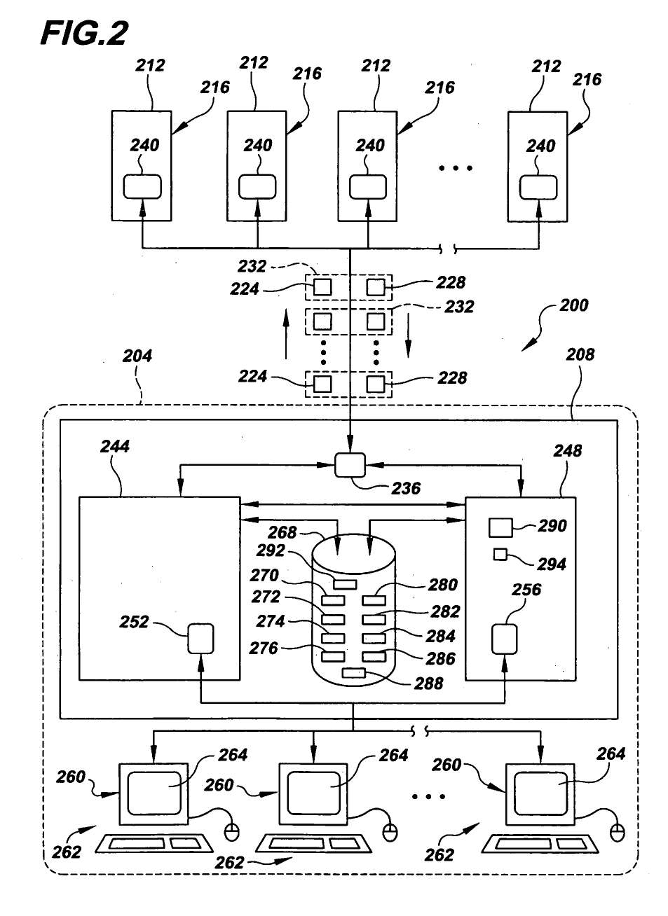

Referring now to the drawings, FIG. 1 is a workflow diagram 100 illustrating a workflow scenario for handling health care service transaction approval requests and responses using an automated service transaction approval (STA) system of the present invention. One embodiment of an STA system (200) of the present invention is described below in detail in connection with FIGS. 2-5. However, workflow diagram 100 gives the reader a broad overview of the general functionality that such an STA system can provide. At step 110, a potential health care service recipient, e.g., a patient, that is covered under a health care plan of a health care payer, e.g., commercial insurance company, commercial health care maintenance organization (HMO), government agency, etc., may contemplate receiving or may require one or more health care services from a health care service provider, e.g., a physician, surgeon, physical therapist, hospital, ambulance service, chiropractor, home care provider, and medical equipment provider, e.g., oxygen therapy equipment provider, among many others. Alternatively, the potential recipient may be a patient-to-be relative to one or more health care services that the recipient is contemplating receiving. For example, the potential recipient may on their own, i.e., without the recommendation of a health care provider, decide they want to consume health services, e.g., undergo rhinoplasty, see a chiropractor, undergo gastric resection, among may other elective procedures and services. In yet other cases, the potential recipient may be required to receive certain health care services without contemplating their need or even being aware of need. Such situations may occur, e.g., in acute care situations, e.g., emergency care and life support care, among others.

Many health care payers require their policy holders to seek payer approval for a wide variety of health care services prior to the payer covering some or all of the costs of those services. As discussed in the Background section above, there are a number of service transaction types presently common in the health care industry, including referrals, pre-certifications and authorizations. In general, health-care providers utilize these service transactions to request payer approval of the health care services under consideration. An STA system of the present invention, such as STA system 200 described in detail below, may utilize electronic STA requests to communicate the request and, optionally, at least some of the information that a payer needs in order to adjudicate the request, determine whether or not to approve the request. Correspondingly, once it has been determined that a potential recipient of health care services needs to request payer approval of such services, at step 120 a health care worker, e.g., a physician's or other health care provider's office staff member, among others, initiates an electronic STA request. As discussed in more detail below, the electronic request may be an electronic data interchange (EDI) request sent over a computer network, such as the Internet, wide area network or local area network, among others. At step 130, the request is sent to the payer under whose policy the potential recipient is requesting approval.

At step 140, the payer adjudicates the STA request and sends an electronic STA reply to the health care provider that made the request. Once the STA reply has been received, at step 150 the STA system of the present invention automatically updates the potential recipient's medical records with the information in the reply in a manner that is easily readable by the health care worker that reviews the information. Some benefits that an STA system of the present invention can provide flow from the partial to complete automation of the STA request processing on the health care provider side of the transaction. Using an STA system of the present invention, health care workers will no longer have to perform a number of manual tasks for each and every STA request, as they presently need to do. For example, health care workers would no longer have to make all STA request by making telephone calls to payers, by accessing payers' secure Websites, or other manual tasks. These conventional manual tasks relating to STA request can be very costly to the health care providers, e.g., due to the health care workers at times having to remain on hold to the payers or the workers having to switch back and forth between software applications. In addition, health care workers would no longer have to manually enter the statuses of every STA request and other information that payers provide in their responses to the requests, as presently needs to be done. Furthermore, an STA system of the present invention can allow health care workers to either automatically process an individual STA request in real time or, alternatively, queue-up a number of requests and have them process automatically in batch mode. Moreover, when health care providers utilize an STA system of the present invention that implements STA requests and replies using the health care services review information transaction EDI standard (a/k/a “278 transaction” (discussed below)), they can become compliant with requirements under the Health Insurance Portability and Accountability Act (HIPAA) of 1996. These and other benefits of an STA system of the present invention will become apparent upon reading the remaining disclosure below and reviewing the claims appended hereto.

FIG. 2 shown an exemplary STA system 200 of the present invention that may be used by, e.g., any one or more health care providers 204 to enable the workflow illustrated in workflow diagram 100 of FIG. 1. In FIG. 2, STA system 200 is shown as being implemented on a provider server 208, which is linked to a plurality of payer servers 212, each corresponding to a distinct payer 216 that insures or otherwise covers at least some of the health care costs of one or more potential service recipients, e.g., patients or patients-to-be. Each payer server 212 may be in communication with provider server 208 via a corresponding respective communications link 220, which may be an open link (preferred), e.g., an Internet link that is generally open any time, or a periodic link, e.g., a dial-up link that is open only during a dial-up session, among others. Each payer 216 may be any one of a number of organizations or entities, such as a commercial insurance company, a health care maintenance organization, or a government agency, among others. While multiple payers 216 are shown to reflect the most common scenario, those skilled in the art will readily understand that STA system 200 may be implemented with payer server 208 linked to only a single payer server 212 of a single payer 216. Such an arrangement may be appropriate, e.g., within a vertically integrated health care delivery system. Generally, the only requirement for implementing STA system 200 is that each payer 216 be capable of handling electronic STA requests 224, i.e., capable of receiving the electronic requests, adjudicating the requests, and sending electronic STA responses 228 to the appropriate provider server 208.

As those skilled in the art will appreciate, electronic requests 224 and responses 228 may have any data format desired. Practically speaking, however, due to U.S. laws relating to HIPAA, health care providers and payers in the U.S. implementing electronic STA approval features in their computer systems must utilize certain EDI standards for these transactions. These standards are promulgated by subcommittee XI2N of the Accredited Standards Committee (ASC) of the American National Standards Institute (ANSI). More particularly, the relevant X12N standard for electronic STA requests 224 and responses 228 is the ANSI ASC X12.338 Health Care Service Information (278 transaction) standard. Details regarding the format and implementation of the 278 transaction 232 may be found in the National Electronic Data Interchange Transaction Set Implementation Guide: Health Care Services Review—Request For Review And Response, 278, ASC X12N 278 (004010X094), published by Washington Publishing Company (www.wpc-edi.com), which is incorporated by reference herein in its entirety. For convenience, the present invention is described with only occasional reference to the 278 transaction 232. However, those skilled in the art will not only readily understand how to implement the present invention using all of the 278 transaction set standards so as to be HIPAA compliant, but also readily understand how to implement the present invention using any EDI standard or scheme other than the 278 transaction 232.

In order to facilitate communications between provider server 208 and each payer server 212, each of these servers may include a respective EDI interface 236, 240. If the 278 transaction 232 is used for electronic STA requests 224 and replies 228, each EDI interface 236, 240 would be configured for handling the specific format of the 278 transaction. If electronic STA requests 224 and responses 228 conform to another EDI standard, each EDI interface 236, 240 would be configured for implementing that standard. In other implementations, EDI interfaces 236, 240 may not be necessary at all. This may be the case, e.g., if payer 216 and provider 204 were part of a vertically integrated health care delivery system that does not need to communicate over a network requiring EDI communication.

STA system 200 may include a health care software system or software application, or simply software 244 for convenience, having at least some level of patient medical records maintenance functionality, such as the ability to store, retrieve and view a variety of information regarding each health care recipient or recipient-to-be. Health care software 244 may, of course, include one or more of many other functions, such as functions relating to patient registration, financials, appointments, chart tracking and visits, among many others. STA system 200 may be based on any suitable legacy health care software applications that may be suitably modified to incorporate the appropriate functionality that permits the desired workflow described generally above relative to workflow diagram 100 of FIG. 1. Examples of such legacy health care applications include the billing and accounts receivable (BAR), hospital patient administration (HPA), patient scheduling (PS), visit management (VM) managed care application (MCA), paperless collection system (PCS) and enterprise task manager (ETM) software applications available as part of the FLOWCAST® software licensed by GE Healthcare, Barrington, Ill., among many other legacy applications available from GE Healthcare and other health care software providers.

When health care software 244 includes one or more legacy applications, the STA functionality may be provided at least in part by a relatively stand-alone STA software application 248, or “module,” that can be interfaced with the health care software with relatively minor changes to the legacy application(s). On the other hand, STA system 200 may be implemented using new software having the STA functionality seamlessly integrated into the software by virtue of the STA functionality being designed into the software from the beginning. In this scenario, health care software 244 and STA software module 248 would be integrated with each other. Consequently, the use of the term “module” and similar terms as used herein and the appended claims primarily denotes commonality of function, rather than connoting any particular software and/or system architectures. Those skilled in the are will readily understand how to implement the present invention in virtually any sort of software architecture and with a myriad of types of hardware given the functionality described and illustrated herein.

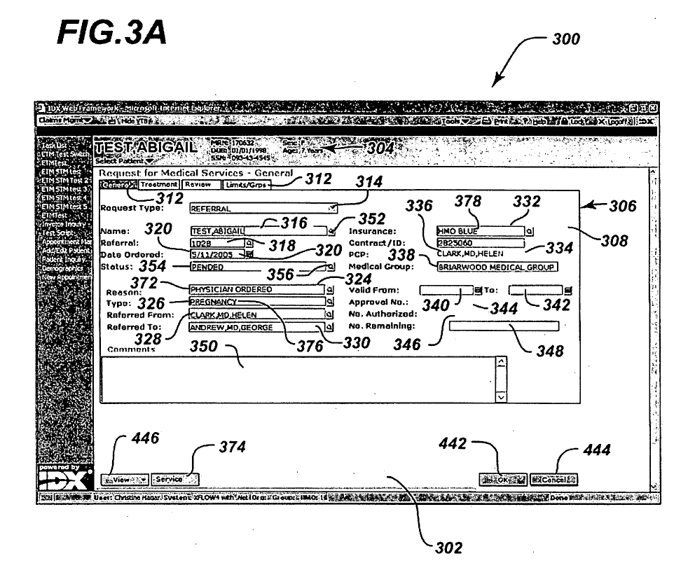

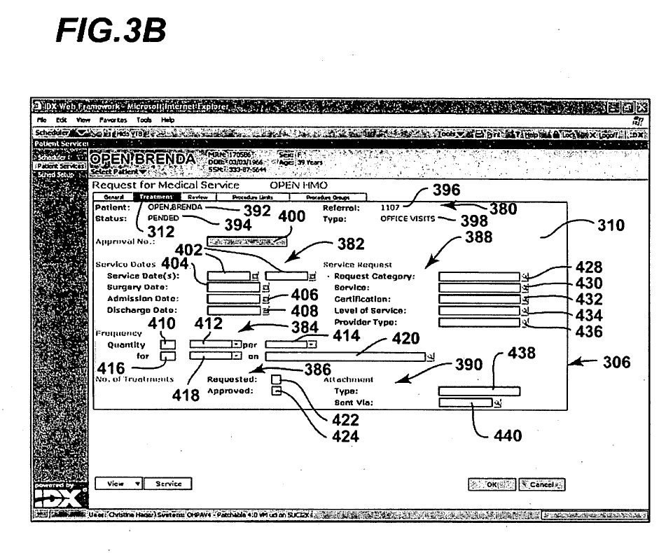

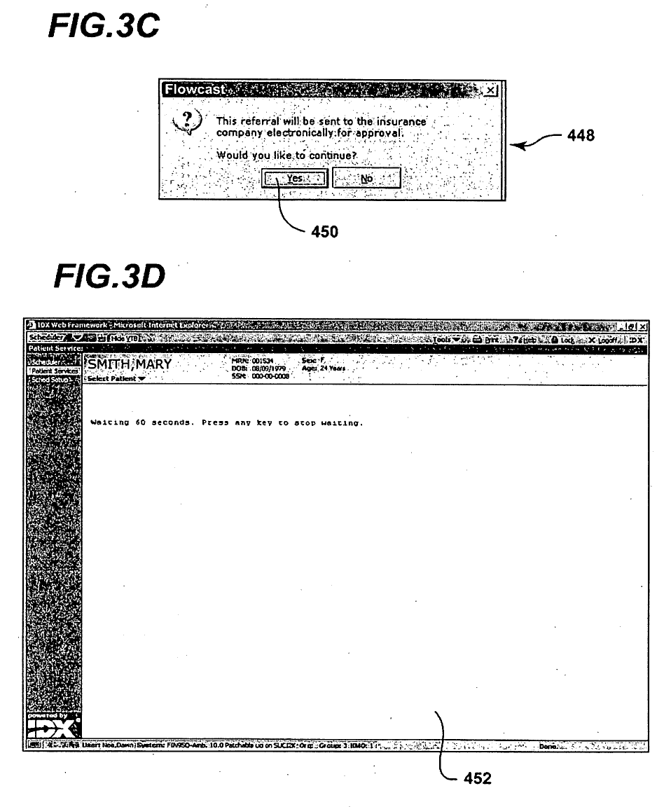

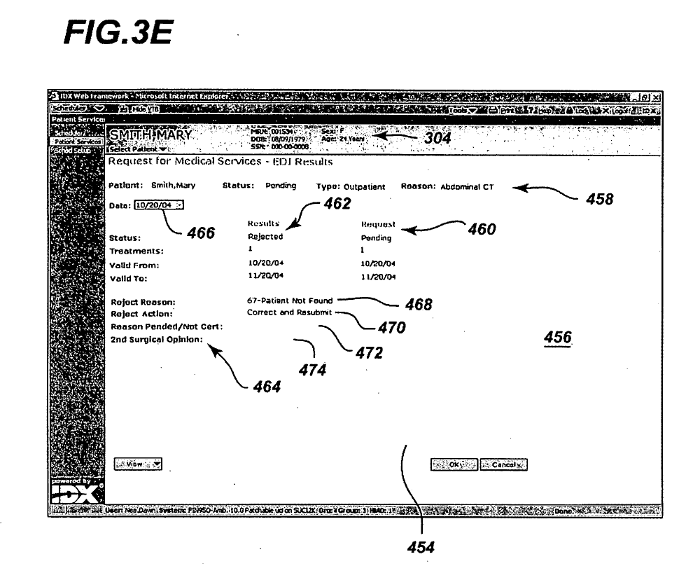

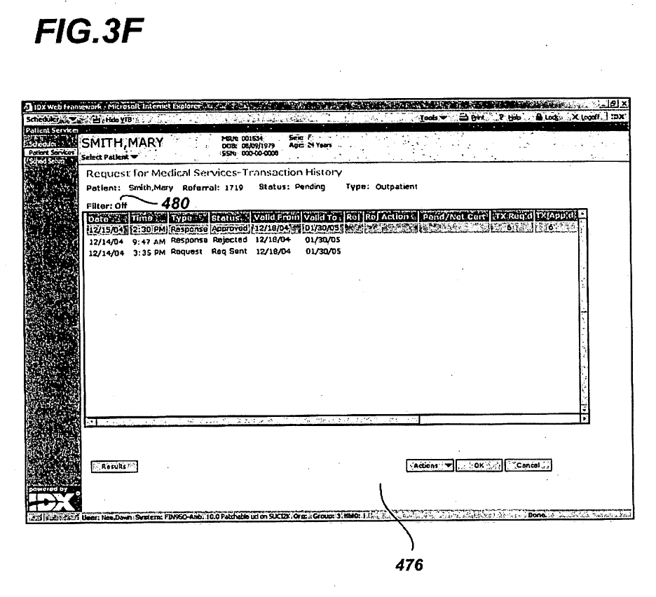

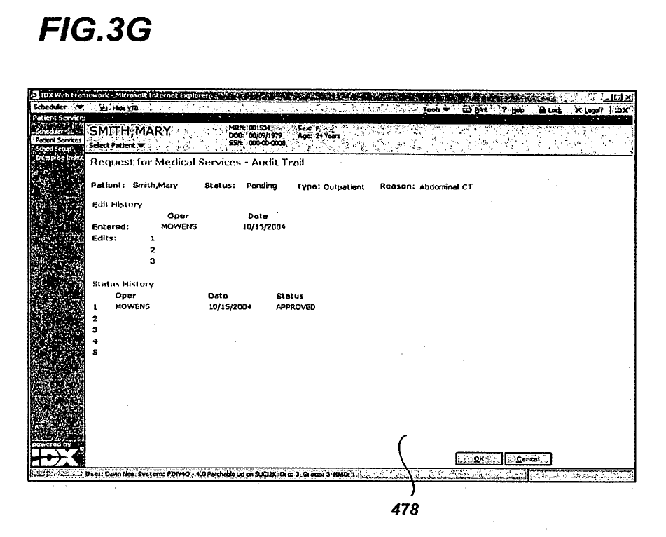

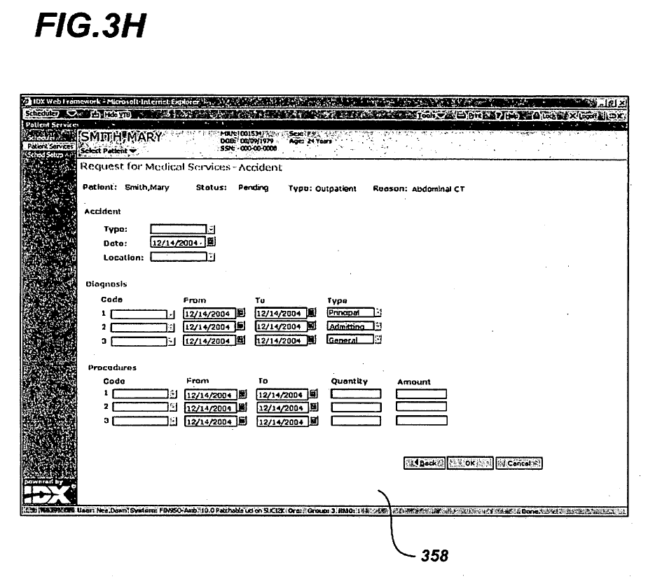

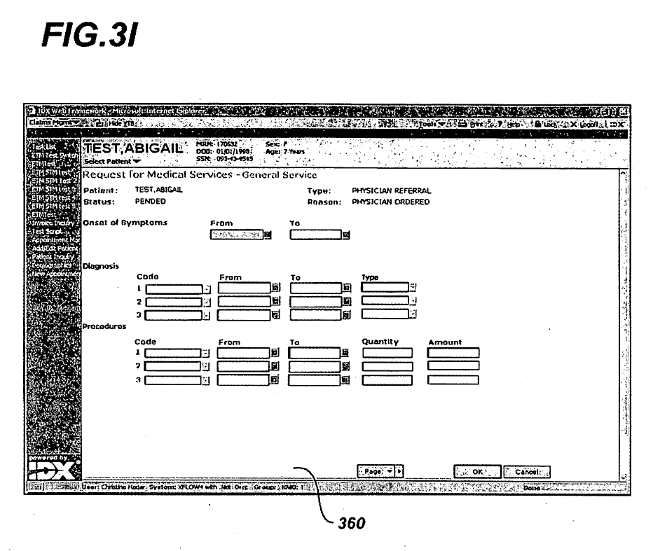

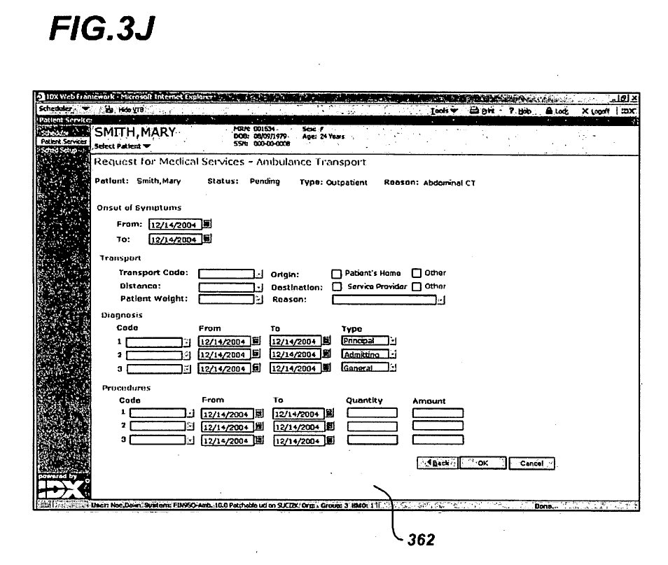

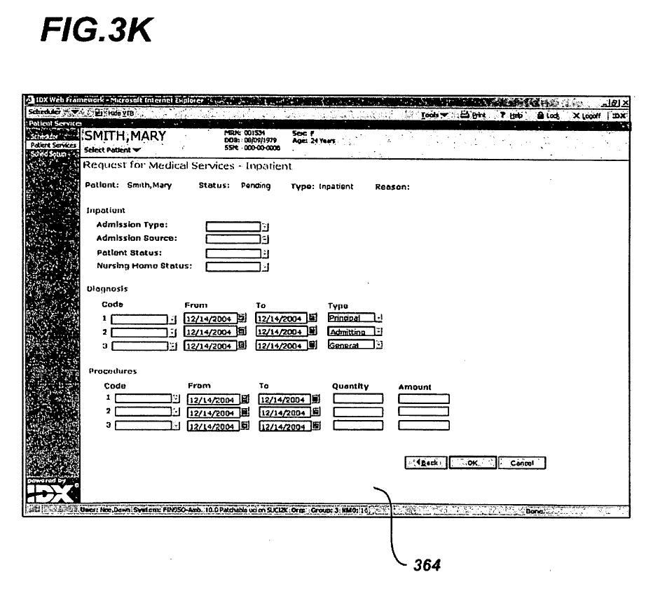

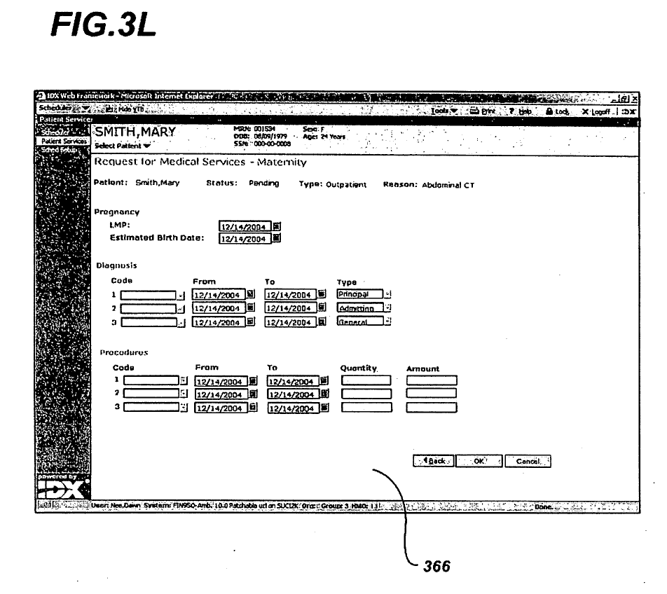

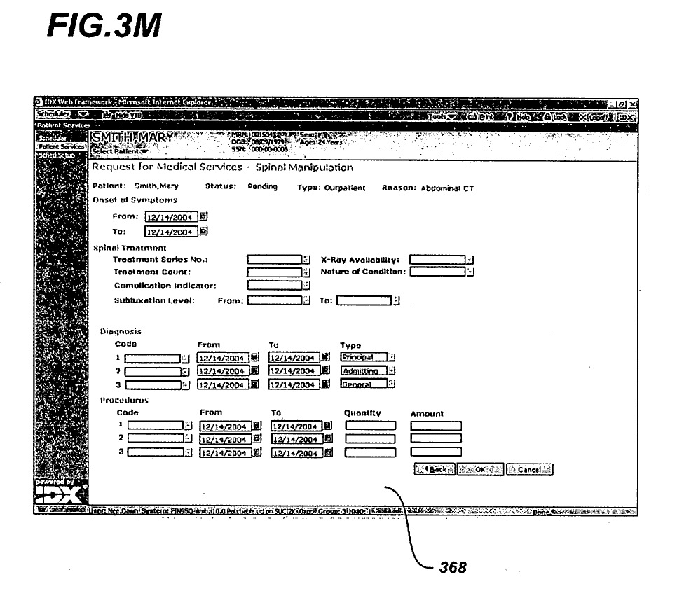

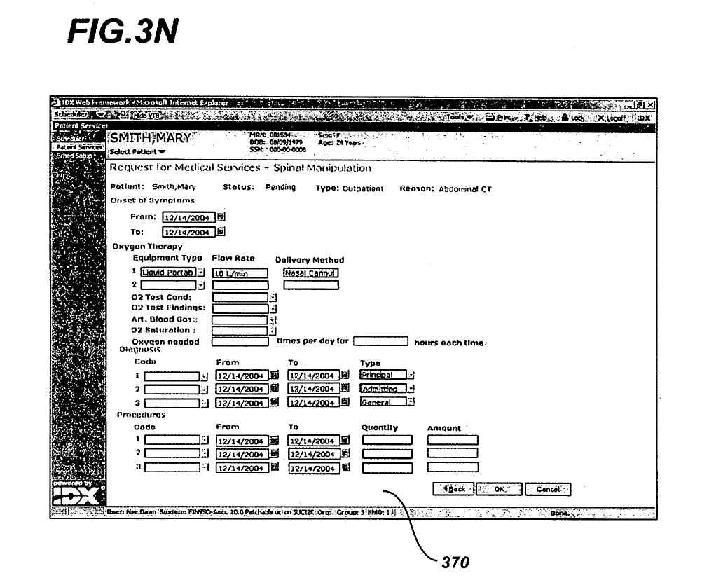

STA system 200 may include a one or more user interfaces (UIs) 252, 256, e.g., graphical UIs (GUIs) for generating various UI screens and/or transmitting Web pages to be displayed on one or more graphical displays 260 of corresponding respective workstations 262 or other human interface devices. As will be seen below, the exemplary embodiment of STA system 200 is a browser-based system, such that GUIs 252, 256 provide Web pages to browser software 264 running on the workstations. In turn, browser software 264 displays the pages on each graphical display 260. Indeed, FIGS. 3A-3O are screenshots of exemplary Web pages generated by GUI 256 of STA module 248. In non-browser-based embodiments of STA system 200, GUIs 252, 256 may provide screens composed for direct presentation on each display 260.

STA system 200 may includes one or more databases 268 that contain various data stores, e.g., tables, dictionaries, trees, etc. that contain, among other things, patient medical records data and data pertaining to the STA functionality of the STA system. For convenience, only one database 268 is shown and, further, is illustrated as residing on provider server 208. However, those skilled in the art will readily appreciate that data relevant to the STA functionality and functionality of health care software 244 in general may, in fact, reside in multiple databases, which may be located in a variety of locations proximate to and/or remote from provider server 208.

Referring now to FIG. 3A, and also to FIG. 2, FIG. 3A illustrates a screenshot 300 of an exemplary STA homepage 302 that may be displayed to a user, e.g., by GUI 256, via appropriate browser software, such as browser software 264. Again, it is noted that STA homepage 302, or like page, may be displayed when STA system 200 is a browser-based system. Of course, when STA system 200 is not browser based, GUI 256 may display a graphical screen (not shown) similar to STA homepage 302 without using a browser. In the following description, STA homepage 302 is described as including various input/display fields, specific field labels and specific hyperlinks and having a particular arrangement of these items. Certainly, those skilled in the art will readily appreciate that the configuration of STA homepage 302 is just one of a large number of configurations possible and, consequently, that the configuration of the STA homepage shown does not limit the scope of the invention, which is defined by the appended claims rather than the specific embodiment shown and described herein.

Navigating to STA homepage 302 from other pages (not shown) of STA system 200 generated by, e.g., health care software 244 may be accomplished in any number of conventional ways and from any number of specific applications. For example, in the context of various FLOWCAST® software applications mentioned above, STA homepage 302 may be accessed from the scheduling application (PS), billing application (BAR) or visit management (VM) application using action codes on various ones of the forms/pages that these applications provide. Those skilled in the art will readily appreciate and understand how, and from which locations, STA homepage 302 may be accessed in any given enterprise system.

STA homepage 302 may include patient general information region 304, or frame, which may list the name and other identifying information of the patient for which an STA request, such as an automated STA request 224, will be made. As those skilled in the art will readily understand, the information to be displayed in patient general information region 304 may be stored in a patient record data-store 270 within database 268 in a conventional, well known manner. STA homepage 302 may also include an STA information input/display region 306, or frame, which generally provides fields that allow a user to input various information into, and/or view various information displayed by, STA system 200. In the embodiment of homepage 302 shown, STA information input/display region 306 may support multiple “forms,” such as a “General” form 308, “Treatment” form 310 (FIG. 3B), “Review” form (not shown) and “Limits/Grps” form (not shown), each accessible from a corresponding respective hyperlink tab 312. In other embodiments (not shown), STA information input/display region 306 may display a single form that may be scrollable in a conventional manner depending upon the length of the form. In yet other embodiments, multiple forms, such as the General and Treatment forms 308, 310 may be accessed in a manner different from the manner shown. For example, an alternative STA homepage (not shown) may display only a General form, while various linked pages may contain Treatment, Review and other forms so that when the linked pages are accessed, they replace the entire STA homepage rather than appearing in a frame of a homepage. Such linked pages may be accessed, e.g., by hyperlinks on the alternative STA homepage.

When a user selects “General” tab 312, GUI 256 displays General form 308, which may include a number of fields for receiving/selecting/displaying various information relevant to a particular STA request for the particular patient at issue, in this case “Abegail Test.” Examples of fields (and corresponding labels) that may be present in General form include a “Request Type” field 314, a patient “Name” field 316, a “Referral” number field 318, a “Date Ordered” field 320, a “Status” field 322, a “Reason” field 324, a “Type” field 326, a “Referred From” field 328, a “Referred To” field 330, an “Insurance” field 332, a “Contract/ID” field 334, a primary care physician (“PCP”) field 336, a “Medical Group” field 338, a “Valid From” field 340, a valid “To” field 342, an “Approval No.” field 344, a “No. Authorized” field 346, a “No. Remaining” field 348 and a “Comments” field 350, among others. Each of these exemplary fields is described below in varying degrees of detail. Typically, though not necessarily, whenever STA homepage 302 is accessed from another page, e.g., a page of health care software 244, the STA homepage will display General form 308 within region 306.

Request Type field 314 may include a pull-down menu (not shown) that allows a user to select which of a predetermined set of request types is most appropriate for the STA request at issue. Examples of request types may include “referral” “pre-certification” and “authorization,” among others. These request types are explained generally in the Background section above. In the present embodiment, the Request Type field 314 is generally only an informational field for noting the type of the request. That is, the value of this field is not used to drive any logic for controlling any functionality of STA system 200. That said, there may be instances in which the value in Request Type field 314 is used to control the function of STA system 200.

Patient Name field 316 will typically display the name of the patient at issue if the user has navigated to STA homepage 302 from a location where a patient has already been selected. If the user arrives at General form 308 without a patient already selected, the use can use a patient name locating/searching feature for locating or searching for the name of the corresponding patient. Such feature may be accessible, e.g., via a feature button or other suitable control 352. For example, in searching for a patient, the user may enter search criteria into patient Name field and select feature control 352 to initiate a search of an appropriate patient name data-store, e.g., patient name dictionary 272 in database 268. Alternatively, feature control 352 may include, e.g., a drop-down menu (not shown) that allows a user to scroll through a list of appropriate names and highlight the correct patient name for selection and display in patient Name field 316.

Referral number field 318 may display a referral numeral, which is a unique number that STA system 200 may automatically assign to the request, e.g., when a user requests a referral number. For example, for a new request not having a referral number, STA system 200 may be configured so that when the user places a “G” in Referral number field 316, the STA system generates a new unique number, e.g., in sequence with previously assigned referral numbers, and populate the Referral number field with the corresponding numeral. Once a referral number has been established, a user may access that referral by the referral number. The generated referral number and other information collected using General form 308 and other forms described herein may be stored in patient record data-store 270 within database 268.

Date Ordered field 320 may include a date on which a request was ordered by the appropriate health care provider 204, e.g., primary care physician. For convenience, this field may default to the date that the request is initiated, but a user may change the default date as appropriate.

Request Status field 322 may display a descriptor 354 of the status of the STA request at issue. Status descriptor 354 may be any descriptor from a group of descriptors that may be stored in an appropriate data store, e.g., dictionary 274, that may be located in database 268. Examples of status descriptors 354 presently contemplated include, “INITIATED,” “EDI SENT,” “PENDED,” “APPROVED,” “APPROVED BY MEDICAL REVIEW”, “AUTO APPROVED,” “CLOSED,” “DELETED,” “EDI APPROVED”, “OPEN,” “PEND CASE MANAGEMENT,” “PENDED RE-ADMISSION CHECK”, “PENDED BY MEDICAL REVIEW,” and “REJECTED,” among others. Of course, other suitable descriptors 354 may be utilized, if desired. As described below, dictionary 274 may include other data, such as codes that correspond respectively to ones of status descriptors in the dictionary. This allows STA system 200 to look up descriptors 354 for displaying in request Status field 322 based on code values.

In a manual mode of operation, i.e., when STA system 200 is used in a conventional manner in which STA requests are adjudicated manually by a health care worker, status descriptor 354 displayed in request Status field 322 may, e.g., be selected from a predetermined group using any suitable selection means 356 known in the art, such as a pull-down menu or search feature. In an automated mode, STA system 200 may populate request Status field 322 automatically depending upon, e.g., actions that a user has taken, whether or not the STA system has sent the STA request 224 or the information returned from a payer 216 in an STA reply 228 to the original STA request. For example, when a user enters STA homepage 302 for the first time in order to create a new STA request, STA system 200 may automatically populate request Status field 322 with the descriptor, “INITIATED.” Then, until some other status is indicated, status descriptor 354 will remain unchanged. For example, once STA system 200 has automatically sent an STA request 224 to the appropriate payer 216, the system may automatically update status descriptor 354 to “SENT,” which may indicate to a knowledgeable user that a request has been sent, but no reply has been received. Then, once STA system 200 has received a corresponding electronic STA reply 228, the system may automatically update request Status field 322 with a descriptor 354 derived from information, e.g., one or more codes, contained in the reply. For example, if the relevant payer 216 indicates in STA reply 228 to STA request 224 that the request is rejected using a numeric code, STA system 200 may automatically update request Status field 322 with the descriptor 354 “REJECTED,” after looking up in dictionary 274 the descriptor corresponding to the numeric code returned in the STA reply.

In one embodiment of STA system 200, it is contemplated that a measure of access control for inhibiting a class of users from accessing all of the various forms, e.g., Treatment form 310 (FIG. 3B) and service forms 358, 360, 362, 364, 366, 368, 370 (FIGS. 3H-3N, respectively) (discussed below), among others. In general, users in this restricted class of user may be referred to as “shell users.” Generally, a shell user is a user that does not have the training, experience and/or other qualifications to complete forms that may require special knowledge. In this case, it may be desirable to restriction access to these forms and allow shell users only access to General form 308. This access control may be provided via request Status field 322. For example, as long as status descriptor 354 in request Status field 322 remains “INITIATED,” STA system 200 may only allow access to General form 308. In order to access other forms, such as Treatment form 310 or a Service form 358-370 (described below), an authorized user would need to change status descriptor 354 from “INITIATED” to another descriptor, such as “PENDED,” in order to allow access to forms other than General form 308.

Request Reason field 324 may display a descriptor 372 of the reason for the corresponding STA referral. The appropriate reason descriptor 372 may be selected from a set of predetermined descriptors that may be determined as a function of the universe of request reasons that STA system 200 is designed to handle. For example, a partial list of suitable reason descriptors 372 may include “PHYSICIAN ORDERED,” “ACCIDENT,” “POST-SURGICAL CARE,” “ELECTIVE SURGERY,” “ABDOMINAL CT,” “ELECTIVE CONSULTATION,” “HOME HEALTH CARE,” “DURABLE MEDICAL EQUIPMENT,” and “TRANSPLANT,” among others. Reason descriptors 372 may be stored in an appropriate data-store, such as dictionary 276, located in database 268. In one embodiment, a user selects the appropriate reason descriptor 372 to be displayed in request Reason field 324. User selection may be facilitated in any suitable manner, such as with a drop-down menu or other selecting means.

Request Reason field 324 may be used to tie the appropriate one of a plurality of service forms, e.g., Service forms 358-370 described below, if any, to a particular STA request. Generally, Service forms 358-370 facilitate the use of General form 308, which is generic across all reasons that an STA request may be made, by providing a separate set of forms that are used only when a certain referral reasons dictate that additional information specific to such reasons (and not requested on the General form) be input into STA system 200. Reasons for needing reason-specific information to be input into STA system 200 may include the situation in which a payer 216 requires the additional information in order to adjudicate an STA request of a particular type and to provide the corresponding patient's medical record with enough information to provide an acceptably complete patient history.

To illustrate this tying concept, assume that a payer 216 requires that an STA request for an accident victim to include the date and location of the accident, two pieces of information that neither General form 308, nor other generic form solicits. In the case of an accident, a user initiating an STA request for the accident victim will populate request Reason field 324 with reason descriptor 372, “ACCIDENT.” Once use as placed the “ACCIDENT” descriptor in field 324, STA system 200 will “know” that Accident service form 358 (FIG. 3H) is to be tied to the present request. In this connection, STA homepage 302 may be provided with a “Service” button 374, hyperlink, etc. that upon selection by a user causes STA system 200 to display Accident service form 358 (FIG. 3H) on any one or displays 260 so that the user may input the appropriate information.

The tying of Service forms to a request based on the reason for request using request Reason field 324 may be implemented in any of a number of ways. For example, dictionary 276 may include a field for each reason descriptor 372 in the dictionary that may contain a pointer, filename, code or other indicator that indicates whether or not each descriptor has a corresponding service form and, if so, the particular service form required. For example, dictionary 276, or portion thereof, may appear functionally as represented in the following Table I:

TABLE I

| Entry No. | Reason Descriptor | Service Form |
|---|---|---|
| 1 | ACCIDENT | pointer to Accident service |
| | | form |
| 2 | PHYSICIAN ORDERED | pointer to General service |
| | | form |
| 3 | ELECTIVE | none |
| | CONSULTATION | |
| 4 | ABDOMINAL CT | pointer to Ambulance |
| | | Transport service form |

It is noted that the tying of a Service form, such as any one or Service forms 258-270, to a particular STA request may be accomplished in other ways. For example, STA system 200 may be configured so that the tying of the Service forms is based on another field, such as request Type field 326, described below. In this case, a dictionary lookup scheme similar to the scheme just described may be used, but using a request type dictionary 280 in database 268. In other embodiments, the tying of Service forms may be implemented using both the request reason and type fields 326. In the latter case, e.g., STA system may first perform a lookup to reason dictionary 278 and then to request type dictionary 280 in order to determine which, if any, Service form should be tied to a particular request. Those skilled in the art will be readily able to implement a suitable tying scheme based on the foregoing description.

Request Type field 326 may display a descriptor 376 of the type of that STA referral. The appropriate type descriptor 376 may be selected from a set of predetermined descriptors that may be determined as a function of the universe of request types that STA system 200 is designed to handle. For example, a partial list of suitable type descriptors 376 may include “PREGNANCY,” “SURGERY,” “INPATIENT,” “OUTPATIENT,” “AMBULANCE TRANSPORT,” “CONSULTATION,” “PHYSICAL THERAPY,” and “SKILLED NURSING,” among others. Type descriptors 376 may be stored in an appropriate data store, such as dictionary 280 mentioned above. In one embodiment, a user selects the appropriate type descriptor 376 to be displayed in request Type field 326. User selection may be facilitated in any suitable manner, such as with a drop-down menu or other selecting means. As discussed above, request Type field 326 may be used in the process of tying a particular Service form to a specific request, either alone or in conjunction with another field.

Referred From field 328 and Referred To field 330 may be used to indicate, respectively, which healthcare provided, e.g., primary care physician, ordered that the request be made (if any) and which health care provider, e.g., a specialist physician, would be providing the requested services if the payer 216 has approved the STA request. In one embodiment, Referred From field 328 may default to the name of the primary care physician. However, a user may override the default, if necessary. Each of Referred From and Referred To fields 328, 330 may be provided with an appropriate selecting means, such as a drop-down menu or search engine, that allows a user to select the appropriate health care provider for that field. If desired, the list of provider names appearing in such a drop-down menu (not shown) or set of provider names search using a search engine may be controlled as a function of the contents of any one or more other fields, such as Insurance field 332 and Medical Group field 338, if such fields are already populated. For example, if Insurance field 332 indicates that the subject patient is a member of an HMO that limits the selection of health care providers to a particular pre-arranged list, the appearance of the indicator 378 for that HMO in Insurance field 332 may cause STA system 200 to display or allow searching only within that list. Insurance and Medical Group fields 332m 338 are discussed below in more detail.

Insurance field 332 may display indicator 378 that indicates the name of a payer 216 that covers the patient at issue. If a patient is selected prior to entering STA homepage 302, Insurance field 332 may be automatically populated based on payer information already stored in the patient's medical records in patient data-store 272. In some cases, a patient may have multiple payers 216. In this case, Insurance field 332 may be set up to display a primary payer based on a ranking or other differentiation already existing in the patient's medical records. Correspondingly, Insurance field 332 may be provided with a drop-down menu that shows a list of eligible payers, which may be obtained from the patient's medical records. Subsets of all of the health care provider names stored in one or more locations on STA system 200 or elsewhere may be assembled or provided in any of a number of ways, depending generally upon how and where such names are stored. For example, if the payer 216 for a particular patient is an HMO, all of the health care providers that are part of the corresponding HMO network may be stored in a data-store, such as dictionary 282, containing only the names, or pointers or other indicators to such names, of the network health care providers. Of course, there are many ways known to skilled artisan for storing and arranging names within an STA system of the present invention, such as STA system 200.

Contract/ID field 334 may display the relevant health care contract identifier for the patient or, alternatively, a patient identification identifier assigned by the corresponding payer 216 indicated in Insurance field 332. The identifier displayed in Contract/ID field 334 may be automatically selected from an appropriate data-store, e.g., a patient medical records data-store 270, a payer/patient data-store, among others, as a function of the patient name appearing in patient Name field 316 and payer identifier 378 appearing in Insurance field 332. Contract/ID field 334 may include a selecting means, e.g., a pull-down menu or search engine, and/or manual-entry functionality as needed. In the former, a particular patient may be covered under multiple contracts issued by the same payer 216. In this case, a pull-down menu may be configured to display the contract identifiers corresponding to such multiple contracts.

PCP field 336 may display the name or other identifier of the subject patient's primary care physician. This identifier may default to a particular identifier previously linked to the subject patient as a function of the name appearing in Name field 316 discussed above. In the case of an HMO or other managed care payer, STA system 200 may pull the name directly from the contract if the contract is stored in the system. PCP field 336 may optionally including a selecting means similar to the selecting means discussed above in connection with Referred From field 328.

Medical Group field 338 may display a name or other identifier that identifies a particular medical group under an HMO or other managed care contract. Identifier may default to a previously stored identifier, e.g., stored with other contract information, as a function of identifier in Contract/ID field 334. If needed, Medical Group field 338 may be provided with a suitable selecting means in the event that there is a reason a user needs to select an identifier other than the default identifier. Medical Group field 338 may remain empty or may not be displayed for any of a number of contracts, such as a non-managed care contract.

Valid From/valid To fields 340, 342 may display dates for which the corresponding STA request is valid. When an electronic STA request 224 is sent and an automatic electronic STA reply 228 is received by STA system 200, the system will automatically populate these fields with the corresponding respective dates contained in the STA reply. When a non-automatic STA reply is received, a user can manually enter the proper dates into Valid From/valid To fields 340, 342, e.g., by either typing in the dates or selecting them from a suitable selection means, such as an interactive calendar, as well known in the art. In the example shown, the STA request has not yet been adjudicated so that STA system 200 has not received an electronic reply 228. Therefore, fields 340, 342 are blank.

Approval No. field 344 may display an approval authorization number or code provided by the respective payer. In an automatic reply mode, STA system 200 will typically pull the number or code from the electronic STA reply 228. In a non-automatic reply mode, a user may enter the number or code manually. Approval No. field 344 is shown as being blank because, again, in this example STA system 200 has not yet received an electronic STA reply 228.

No. Authorized field 346 may display a numeral corresponding to the number of treatments approved by the respective payer 216. As shown, No. Authorized field 346 is shown as being display only. In this case, STA system 200 may pull the number of treatments from an electronic STA reply 228. However, in other embodiments, e.g., where an STA reply is not received in a manner that allows STA system 200 to automatically fill in No. Authorized field 346, the No. Authorized field may allow a user to enter the appropriate numeral manually. Of course, No. Authorized field 346 may not be used for every type of STA request. For example, a referral to a specialist physician for a specific diagnosis consultation may only require approval, since at that point there is no treatment or need for follow up visits.

No. Remaining field 348 may display a numeral corresponding to the number of treatments remaining relative to the approved number identified in No. Authorized field 346. STA system 200 may utilize the contents of No. Authorized field 346 and other data stored in the system for automatically determining the number of treatments remaining. In other embodiments, STA system 200 may be configured to allow manual input into No. Remaining field 348 by a user, e.g., if the system does not contain the data necessary for an automatic calculation of the number of remaining treatments. No. Authorized and No. Remaining fields 346, 348 are blank because in this example STA system 200 has not yet received an electronic STA reply 228. General form 308 may also include a Comments field 350 that allows a user to input any relevant comments about the STA request.

If a particular STA request relates to a specific treatment or series of treatments or surgery, user may need to select Treatment tab 312. Upon selection of Treatment tab 312, STA system 200 may display in STA information input/display region 306 Treatment form 310 of FIG. 3B. The user can, e.g., navigate to Treatment form 310 after filling out the appropriate Service form 358-370 (FIGS. 3H-3N). Treatment form 310 allows a user to input/view information not available or able to be input on General form 308 (FIG. 3A) that relates more particularly to treatment or surgery, rather than the STA request generally. Treatment form 310 may be partitioned into several regions, such as a general information region 380, a Service Dates region 382, a Frequency region 384, a No. of Treatments region 386, a Service Request region 388 and an Attachment region 390, among others.

General information region 380 may display general information about the particular STA request, such as the patient name, request status, referral number, request type and approval number/code, in, respectively, a Patient name field 392, a request Status field 394, a Referral number field 396, a request Type field 398, and an Approval No. field 400. The information displayed in fields corresponds to information displayed in the like fields of General form 308 of FIG. 3A, except that Referral number field 396 contains a unique identification number generated by STA system 200 (FIG. 2) when a user generates that request.

In FIG. 3B, Service Dates region 382 may include a number of date fields, such as one or more Service Date(s) fields 402, a Date of Surgery field 404, an Admission Date field 406 and a Discharge Date field 408. Each Service Date(s) field 402 may be used to indicate a proposed or actual date of the service for which the corresponding STA request is made. In the present embodiment, Service Date(s) fields 402 are only used for non-procedure-specific, non-surgical outpatient services. This is so because in the present embodiment procedure-specific related information, such as date(s) and procedure codes, are handled using a General Service form 360 (FIG. 3I), discussed in more detail below, and inpatient dates are handled using Admission Date and Discharge Date fields 406, 408. Surgery Date field 404 may be used for surgeries not specified using General Service form 360. This is so because information relating to surgeries covered by particular codes available on General Service form 360 (FIG. 3I) are input on that form. Admission Date and Discharge Date fields 406, 408 are used to specify the particular dates at issue. In the present embodiment, if a service is an inpatient service, Admission Date and Discharge Date fields 406, 408 are used in lieu of Service Date field(s) 402. Each of the date fields 402-408 in Service Dates region 382 may be operatively configured for keyed entry or entry using a suitable selecting means, such as an interactive pull-down calendar, among others.

STA system 200 may be operatively configured to control which one or more of date fields 402-408 are active or displayed depending upon the request type present in request Type 398 (and/or Reason field 324 of General form 308 of FIG. 3A). For example, if the request type is “Inpatient,” STA system 200 may inactivate, or not display, Service Date(s) field(s) 402. Conversely, if the request type is “Outpatient,” STA system 200 may not inactivate, or not display, Admission Date and Discharge Date fields 406, 408. In the first of the two examples just mentioned, another example is that if STA system 200 recognizes that the request reason is non-surgical in nature, then the system may also deactivate, or not display, Surgery Date field 404 in addition to Service Date(s) fields 402. Those skilled in the art will readily understand how to implement such control using dictionaries or other data-stores for the request types and reasons.

Frequency region 384 may contain a number of fields, such as fields 410-420, for displaying information regarding the frequency at which the subject patient would receive the service for which an STA request is made. For example, a user may make appropriate selections in fields 410-420 so that the sentence created by these fields read, 3 times per Week for 6 Wks on Mon, Tue, Fri. In the preceding sentence, the underlined items are items entered or selected by a user assembling the request. Numeric fields 410, 416 may be configured to received keyed entries, whereas descriptive fields 412, 414, 418, 420 may include pull-down menus that each provide a range of descriptors appropriate for that field. Another exemplary sentence constructed from fields is 1 hour per day for 5 days on ______. In this example, “on” field 420 is not used and thus would remain blank.

No. of Treatments region 386 may contain a number of treatments Requested field 422 and a number of treatments Approved field 424. Requested field 422 may display and receive a numeral corresponding to the number of treatments being requested with that STA request. Approved field 424 may be similar to No. Authorized field 346 of General form 308 of FIG. 3A, in that it may be used to display and/or accept a numeral corresponding to the number of treatments approved by a payer 216, e.g., in an automated or non-automated electronic STA reply.

Service Request region 388 may include a number of fields relating to the service being requested. For example, Service Request region 388 may include a Request Category field 428, a Service field 430, a Certification field 432, a Level of Service field 434, and a Provider Type field 436, among others. Request Category field 428 may display a descriptor of the category to which the corresponding STA request belongs. For example, in the context of a 278 transaction 232 under HIPAA, a payer 216 receiving an electronic STA request 224 requires the request to include a code indicating the request category. Examples of request category descriptors and uses include the examples appearing in the following Table II:

TABLE II

| Descriptor | Usage |
|---|---|
| Admission Review | Use for a request regarding admission to a |
| | health care facility |
| Health Services Review | Use for a request for a review of one or more |
| | services relating to an episode of care |
| Specialty Care Review | Use for a request for a referral to a specialty |
| | health care service provider |

The appropriate descriptor may be entered into Request Category field 428 manually using, e.g., a pull-down menu or other selecting means that allows for selection from among the valid descriptors. In some embodiments, it may be desirable to have STA system 200 populate Request Category field 428 automatically, e.g., as a function of the indicators present in request Type and/or Reason fields 396, 398 discussed above. Such automated population may be implemented, e.g., by adding a field to reason dictionary 278 discussed above that contains the appropriate category descriptor or pointer, code or other indicator that indicates the appropriate code for each corresponding request type and/or reason.

Service field 430 may display a descriptor indicating the class of the service of the STA request. Like the request category, a payer 216 may require in each electronic STA request 224 a code that identifies the class of the service. For example, in the context of a 278 transaction 232 under HIPAA, a payer 216 receiving an electronic STA request 224 requires the request to include a code indicating the service class. Examples of service class descriptors and uses include the examples shown in the following Table III:

TABLE III

| Descriptor | Usage |
|---|---|
| Radiation Therapy | Use for a request for a review of radiation |
| | therapy |
| Surgical | Use for a request for surgical treatment |
| Durable Medical | Use for a request to purchase durable medical |
| Equipment Purchase | equipment |

The appropriate descriptor may be entered into Service field 430 manually using, e.g., a pull-down menu or other selecting means that allows for selection from among the valid descriptors. In some embodiments, it may be desirable to have STA system 200 populate Service field 430 automatically, e.g., as a function of the indicators present in request Type and/or Reason fields 396, 398 discussed above. Such automated population may be implemented, e.g., by adding a field to reason dictionary 278 discussed above that contains the appropriate class descriptor or pointer, code or other indicator that indicates the appropriate code for each corresponding request type and/or reason.

Certification field 432 may contain a descriptor that indicates the type of certification for an electronic STA request 224. Like the request category and service class just discussed, a payer 216 may require in each electronic STA request 224 a code that identifies the type of certification. For example, in the context of a 278 transaction 232 under HIPAA, a payer 216 receiving an electronic request 224 requires the request to include a code indicating the certification type. Examples of certification descriptors include the examples appearing in the following Table IV:

TABLE IV

| Descriptor | Comment |
|---|---|
| Appeal-Immediate | Use only for request for review of a request |
| | for emergency or urgent services. This |
| | descriptor is used in conjunction with Level |
| | of Service field, described below. |
| Appeal-Standard | Use for non-emergency or non-urgent service |
| | appeals |
| Cancel | |
| Extension | |
| Initial | |
| Renewal | |
| Revised | |

The appropriate descriptor may be entered into Certification field 422 manually using, e.g., a pull-down menu or other selecting means that allows for selection from among the valid descriptors.

As mentioned in the immediately foregoing table, Level of Service field 434 may display an identifier, e.g., numeral, code, descriptor, etc., that identifies the level of service for an Appeal-Immediate type certification. A user may enter the appropriate identifier into Level of Service field 434 manually using, e.g., a pull-down menu or other selecting means that allows for selection from among the valid identifiers. STA system 200 may be configured to inactivate, or not display, Level of Service field 434 when descriptor in Certification field 432 is other than “Appeal-Immediate.” In the present embodiment that utilizes the HIPAA 278 transaction 232 discussed above, there are two levels of service possible for an immediate appeal, namely, “Emergency” or “Urgent.” When STA system 200 generates an electronic STA request 224, the system may place the appropriate 278 level of service code in the proper location within the request.

Provider Type field 436 may display a descriptor of the type of health care provider that will be providing the requested services if the STA request is approved. As with other fields in Service Request region 388, a user may manually input or select the appropriate descriptor, e.g., using a pull-down menu or other selecting means that allows selection from among a set of valid descriptors. A payer 216 may use the value of Provider Type field 436 to track the type of health care provider that the insured is using. In the context of the 278 transaction, valid provider type descriptors include, “Admitting,” “Assisting,” “Attending,” “Consulting,” “Operating,” “Ordering,” “Other Physician,” “Primary Care Physician,” “Performing” and “Surgeon.”

As will be understood by those skilled in the art, in the context of a 278 transaction the electronic transaction utilizes numeric codes for each of the descriptors/identifiers discussed above in connection with fields 428-436 of Service Request region 388. Consequently, for implementing a 278 transaction set, STA system 200 should include means for populating the 278 STA requests 224 with the appropriate codes corresponding to the selected descriptors/identifiers and a means for translating such codes returned from a payer 216 in the corresponding electronic STA reply 228. This may be done in a number of way, including providing one or more lookup dictionaries (not shown) that contain the descriptors/identifiers and the corresponding respective codes. Then, when STA system 200 generates an electronic STA request 224, in populating the various fields of the request the system will translate the descriptors/identifiers into the appropriate codes and place those codes into the request. These dictionaries could then also be used in the reverse manner when translating an electronic STA reply 228. That is, STA system 200 may find the appropriate descriptor/identifier for each code returned in the electronic STA reply 228, e.g., for checking to see whether the payer changed any of the codes and changing the descriptors in the appropriate fields 428-436 as needed.

Attachment region 390 of Treatment form 310 may include a number of fields, such as a Type field 438 and a Sent Via field 440. Many types of services for which STA system 200 is used require a payer 216 to make the approval decision after reviewing various supporting information, e.g., clinical notes, radiological images, prognosis notes, etc., that is not input into the system using forms. This supporting information is often sent to the appropriate payer 216 outside of STA system 200. For example, copies of supporting information is often sent to the payer via mail, overnight delivery, fax and the like. Attachment region 390 allows a user to describe this supporting information, e.g., using Type field 438 to enter a descriptor indicative of the type of the supporting information, and using Sent Via field 440 to indicate the mode of delivery from the appropriate health care provider to the relevant payer 216. Each of fields 438, 440 may include a selecting means, e.g., drop-down menu, that allows a user to select the appropriate descriptor from among a set of valid descriptors. Examples of type descriptors for Type field 438 include “ProgNote,” “ClinicNotes,” “RadImage,” “CT Scan,” among others. Examples of delivery mode descriptors for Sent Via field 440 may include, e.g., “Fax,” “1^{st} Class Mail,” “Fax,” “Overnight Delivery,” etc.

For the sake of completeness, it is noted that the screenshot of FIG. 3B differs from the screenshot of FIG. 3A in a number of ways other than being different types of forms. These other differences include the difference in the fictitious patent names and patent data, as well as the differing numbers of hyperlink tabs 312. These and other differences are artifacts of the screenshots being created at different stages of the development of GUI 256 (FIG. 2). Regarding the differing numbers of hyperlink tabs 312, it will be appreciated that for FIG. 3B, the single Limits/Grp tab of FIG. 3A was split into two distinct Procedure Limits and Procedure Groups tabs. Regardless of the particular way in which GUI 256 is expressed, the underlying functionality of STA system 200 may remain the same.

Referring again to FIGS. 3A and 2, STA homepage 302 (FIG. 3A) may include several action buttons or other selectors, such as OK button 442, Cancel button 444, View button 446, and Service button 374, among others. STA system 200 may utilize OK button 442 any one or more ways. For example, in the shell-user/advanced user context described above relative to Status field 322, when in shell-user mode, e.g., when the Status field displays “Initial,” and the user actuates OK button 442, STA system 200 may simply file all of the data input by the shell user in an appropriate location within the system, e.g., in the patient's medical records in data-store 270. Once the data has been filed, STA system 200 may return the user to the page (not shown) from which they entered STA homepage 302.

However, if STA system 200 is in advanced user mode, e.g., when Status field 322 indicates a status other than “Initial,” the system may validate that all required fields are filled in and then file all data present in the various forms of the system. If STA system 200 determined that all required fields have been filled in, in the 278 transaction context, the system will determine whether or not the indicated payer 216 is a valid trading partner. If the payer 216 is a valid trading partner, STA system 200 will invoke EDI rules in order to determine whether the electronic STA request 224 should be sent. These rules may be set up my the particular health care provider 204 making the request. For example, the provider 204 may decide that the status of the STA request 224 must be “Pending” in order to send the request. After STA system 200 determines that the STA request 224 should be sent, the system may display to the user a pop-up window, such as pop-up window 448 of FIG. 3C, or other indicator that asks the user to confirm or deny that the request should be sent.

If the user actuates Yes button 450 of pop-up window 448, STA system 200 (FIG. 2) may send the STA request 224 to the appropriate payer 216. For a real-time transaction, STA system 200 may display a waiting page, e.g., waiting page 452 of FIG. 3D, that indicates that the system is waiting for an STA reply 228 from the payer 216. At this page 452, the user can either wait for the STA reply 228 or exit the waiting mode. If the user waits for the STA reply 228 and the reply arrives at STA system 200 within the predetermined waiting period, the system may display a results page, such as results page 454 of FIG. 3E. If STA system 200 does not receive the STA reply 228 within the waiting period, the system will display on the appropriate workstation 262, e.g., in a pop-up window (not shown), a message such “Timeout Reached. Leaving the Request,” or the like. However, the transaction may continue processing in the background. If the user decides to stop waiting, STA system 200 may be configured to return the user to the page (not shown) they were viewing prior to entering STA homepage 302 (FIG. 3A), but also continue processing the transaction.

Regarding Cancel button 444 on STA homepage 302 (FIG. 3A), STA system 200 may be configured so that upon actuation of the Cancel button the system may remove the STA homepage from display on workstation 262 and return to displaying the page (not shown) displayed immediately prior to the STA homepage being displayed.

Referring now to FIGS. 3E and 2, results page 454 may include patient general information region 304, which was described above in connection with STA homepage 302 of FIG. 3A. Results page 454 may also include a summary frame 456 that displays various information regarding the corresponding respect STA request and results of the payer adjudication, if the results have been received from the payer 216, either electronically via STA reply 228 or by other means, and input into STA system 200, either automatically or manually. For example, summary frame 456 may include a general information region 458, a Request information region 460, a Results information region 462, and field identifier region 464, which contains descriptors for the fields of the Request and Results information regions.

General information region 458 may contain any pieces of information previously stored that provide a user with relevant general information regarding the particular STA request at issue. In the embodiment shown, the information that the designer of results page chose to display are patient name, status of the STA request, type of the request, reason for the request, and date of the reply to the STA request. STA system may pull each of these pieces of information from their storage location, e.g., patient medical records data store in database. Regarding the date, general information region 458 may be provided with a Date field 466 that displays the date of the STA reply from the payer 216, if any, or the most recent reply if a particular STA request has had more than one reply. In the latter case, e.g., if the first reply indicated that certain information needed to be changed, Date field 466 may include a selector, e.g., a pull-down menu, that allows a user to select by date which of the STA replies to view. Whichever STA reply a user selects, STA system 200 will display the appropriate information for that reply in Results information region.

Regarding the “Status” information in each of Request and Results information regions 460, 462, the status indicated in the Request information region is the status of the STA request 224 when STA system 200 sent the request out in an electronic form to the appropriate payer 216. The status indicated in Results information region 462, however, is determined by the status contained in the STA rely 228 from the payer 216. In the HIPAA 278 transaction 232, the valid statuses include: “Certified in Total;” “Not Certified;” “Pended;” “Modified;” “Contact Payer;” and “No Action Required.” As these statuses will be indicated in an STA reply 228 with a numeric code (not shown), STA system 200 may include a dictionary or other data-store that allows the system to translate codes into the corresponding descriptors.

Like the “Status” information, the “Treatments,” “Valid From” and “Valid To” information in each of Request information and Results information regions 460, 462 is taken from the appropriate data-store, e.g., patient records data-store 270, in STA system 200 and translated from codes as appropriate. Since a payer 216 may change any of this information as originally requested in the STA request 224, the values for these pieces of information may differ from Request information region 460 to Results information region 462. In the illustrated example, however, the payer 216 did not change any of this information. This may be so in the present example, e.g., because as discussed below, the payer 216 could not find the patient in its records and, therefore, the processing of the STA request 224 did no proceed beyond an initial patient matching algorithm.

In addition to the foregoing field identifiers, field identifier region 464 may also include one or more additional field identifiers that correspond to like fields in Results information region 462. In the present example, field identifier region 464 also includes “Reject Reason,” “Reject Action,” “Reason Pended/Not Cert” and “Second Surgical Opinion” identifiers and, correspondingly Results information region includes Reject Reason, Reject Action, Reason Pended/Not Cert and Second Surgical Opinion fields 468-474.

When a payer 216 has rejected an STA request, Reject Reason field 468 may display a descriptor of the reason that the payer rejected the request. In the context of a HIPAA 278 transaction implementation, rejection reasons include, but are not limited to the rejections listed in the following Table V:

TABLE V

| Descriptor | Code |
|---|---|
| Authorized Quantity Exceeded | 04 |
| Required Application Data Missing | 15 |
| Input Errors | 33 |
| Out of Network | 35 |
| Testing Not Included | 36 |
| Request Forwarded to and Decision | 37 |
| Response Forthcoming from an External | |
| Review Organization | |
| Authorization/Access Restrictions | 41 |
| Unable to Respond at Current Time | 42 |
| Invalid/Missing Provider Identification | 43 |
| Invalid/Missing Provider Name | 44 |
| Invalid/Missing Provider Specialty | 45 |
| Patient Not Found | 67 |

Since in a 278 transaction 232 the electronic STA reply 228 includes only the codes corresponding to the rejection reasons, STA system 200 may include a data-store, e.g., dictionary 284, that allows the system to translate the received codes into the appropriate descriptors for display in Reject Reason field 468. If the payer 216 did not reject the STA request 224, Reject Reason field 468 may simply be empty.

When a payer 216 has rejected the STA request 224, Reject Action field 470 may display a descriptor of the action that the payer indicates that the health care provider 204 take. In the context of a HIPAA 278 transaction implementation, reject actions include, but are not limited to the reject actions appearing in the following Table VI:

TABLE VI

| Descriptor | Code |
|---|---|
| Please Correct and Resubmit | C |
| Resubmission Not Allowed | N |
| Please Resubmit the Original Transaction | P |
| Do Not Resubmit; We Will Hold Your | Y |
| Request and Respond Again Shortly | |
| Resubmission Allowed | R |

Since in a 278 transaction 232 the electronic STA reply 228 includes only the codes corresponding to the reject actions, STA system 200 may include a data-store, e.g., dictionary 286, that allows the system to translate the received codes into the appropriate descriptors for display in Reject Action field 470. If the payer 216 did not reject the STA request 224, Reject Action field 470 may simply be empty.

When a payer 216 has either pended or did not certified the STA request 224, Reason Pended/Not Cert field 472 may display a descriptor of the reason that the payer pended or did not certify the request. In the context of a HIPAA 278 transaction implementation, reasons for pending or not certifying include, but are not limited to the reasons appearing in the following Table VII:

TABLE VII

| Descriptor | Code |
|---|---|
| Out of Network | 35 |
| Testing not Included | 36 |
| Request Forwarded To and Decision | 37 |
| Response Forthcoming From and External | |
| Review Organization | |
| Authorization/Access Restrictions | 41 |
| Inquired Benefit Inconsistent with Provider | 53 |
| Type | |
| Inconsistent with Patient's Age | 69 |
| Inconsistent with Patient's Gender | 70 |
| Not Medically Necessary | 82 |
| Level of Care Not Appropriate | 83 |
| Certification Not Required for this Service | 84 |
| Certification Responsibility of External | 85 |
| Review Organization | |
| Primary Care Service | 86 |
| Exceeds Plan Maximums | 87 |
| Non-Covered Service | 88 |
| No Prior Approval | 89 |
| Requested Information Not Received | 90 |
| Duplicate Request | 91 |
| Service Inconsistent with Diagnosis | 92 |
| Pre-Existing Condition | 96 |
| Experimental Service or Procedure | 98 |
| Require Medical Review | E3 |

Since in a 278 transaction 232 the electronic STA reply 228 includes only the codes corresponding to the reasons for pending or not certifying an STA request 224, STA system 200 may include a data-store, e.g., dictionary 288, that allows the system to translate the received codes into the appropriate descriptors for display in Reason Pended/Not Cert field 472. If the payer 216 did not pend or did not certify the STA request 224, Reason Pended/Not Cert field 472 may simply be empty.

Referring again to FIG. 3A, as mentioned above, STA homepage 302 may include View button 446, or other selector. When selected, View button 446 may cause STA system 200 to provide a user with the option of accessing a EDI Transaction History page 476 (FIG. 3F), an Audit Trail page 478 (FIG. 3G) or the corresponding patient's eligibility list (not shown). As shown in FIG. 3F, Transaction History page 476 presents in a different arrangement some of the information discussed above. As those skilled in the art will appreciate, Transaction History page 476 may be provided with various functionality, such as a filter 580 that allows a user to filter the results displayed on the page as a function of various filter criteria, such as, e.g., status, type, date or any other relevant information displayed on this page. As shown in FIG. 3G, Audit Trail page 478 also displays in a different configuration information discussed in detail above. Audit Trail page 478 also displays the name(s) of the user(s), or operator(s), that originally entered and edited the corresponding STA request.

Services button 374 (FIG. 3A) on STA homepage 302 was described briefly above relative to an example explaining how the functionality of this button may be tied to, e.g., the reason for the STA request appearing in Reason field 324. In the example, the reason for the STA request was the occurrence of an accident. Consequently, upon actuation of Service button 374, STA system 200 displayed Accident Service form 358 (FIG. 3H) to the user. Accident Service form 358 permits a user to enter into STA system 200 information of the type that a payer 216 (FIG. 2) may need in adjudicating an STA request relating to an accident. However, Accident Service form 358 is one example of a variety of Service forms that STA system 200 may provide and/or tie the access of to the values of one or more of the fields on STA homepage 302, such as Reason field 324. Examples of other Service forms include the General Service, Ambulance Transport, Inpatient, Maternity, Spinal Manipulation and Oxygen Therapy service forms 360-370 illustrated, respectively, in FIGS. 3I-3N. Each of these forms is self-explanatory and allows a user to enter service-specific information that a payer 216 may need, but that is not able to be input into STA system 200 via other forms on the system.

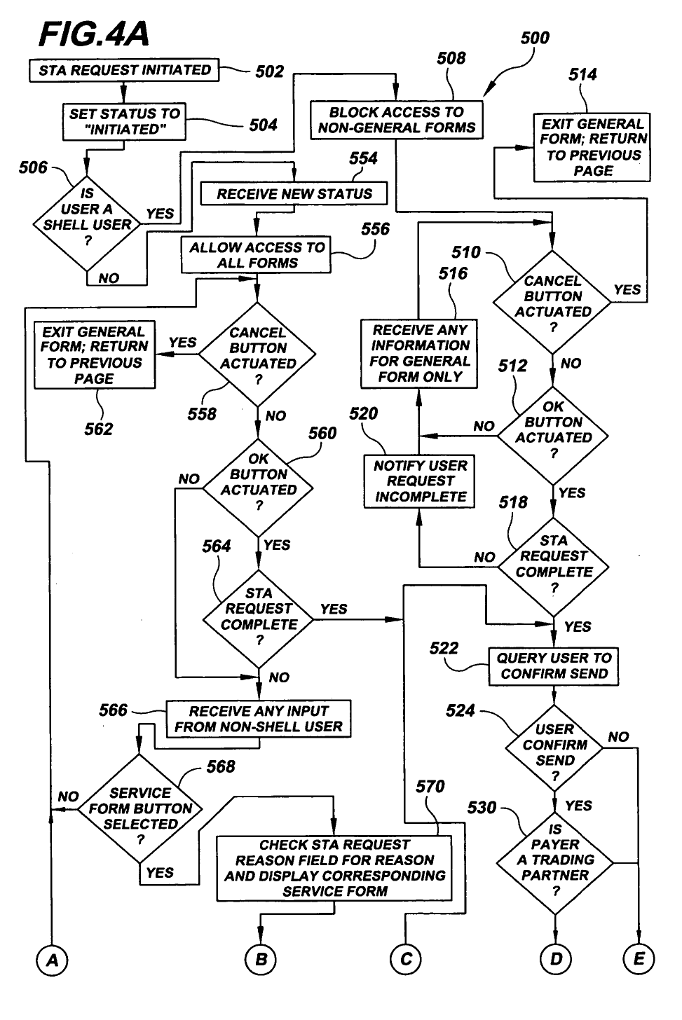

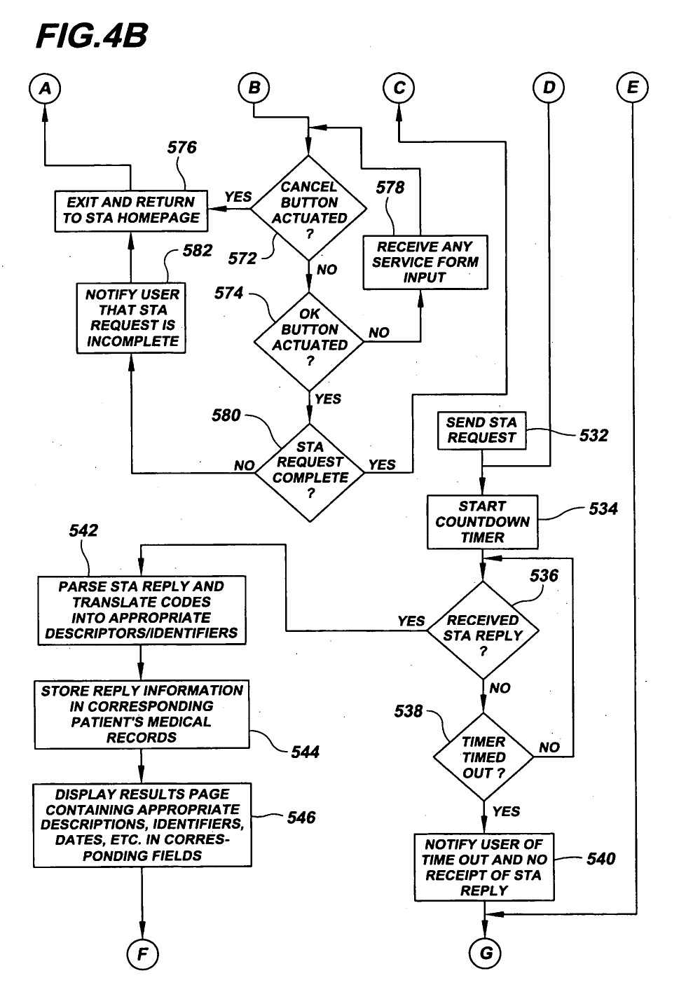

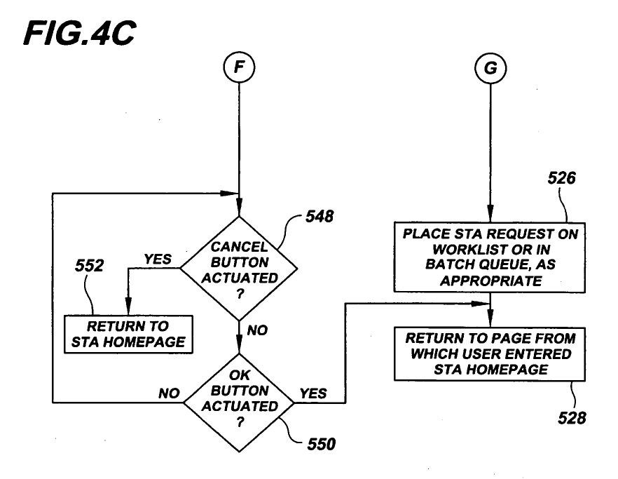

Referring now to FIGS. 4A-4D, and also to FIGS. 2, 3A, 3C-3E and 3H-3N, FIGS. 4A-4C illustrate an automated STA method 400 of the present invention that may be implemented on an STA system of the present invention, such as STA system 200 of FIG. 2. In general, STA method 500 may begin at step 502 with an STA request 224 being initiated by a user, in this case either a shell user (as described above in connection with FIG. 3A) or an experienced user. Typically, an STA request 224 is initiated by a user entering STA homepage 302. At step 504, STA system 200 may automatically set the status of the request, as indicated, among other places, in Status field 322 on General form 308 (FIG. 3A) to “INITIATED.” Then, at step 506, the question is asked whether or not the user is a shell user. If the user is indeed a shell user, the user leaves the status as INITIATED and at step 508 STA system blocks the shell user from accessing all forms that requires special knowledge or experience to complete properly, e.g., Treatment form 310 (FIG. 3B) and Service forms 358-370 (FIGS. 3H-3N). STA system 200 may block access to such forms, e.g., by using the status “INITIATED” as a flag that does not allow the computer instructions that display these forms to be executed.

At steps 510 and 512, STA system 200 may determine, respectively, whether or not the user has actuated either Cancel button 444 or OK button 442 on STA homepage 302 of FIG. 3A. If the user has actuated Cancel button 444, at step 514 STA system 200 may exit from STA homepage 302 and return to page from which the user originally accessed the STA homepage. On the other hand, if the user has not actuated Cancel button 444, STA system 200 continues displaying STA homepage 302. If at step 512 the user has not actuated OK button 442, at step 516 STA system 200 will receive and store any information that the user inputs into General form 302. Steps 510, 512 and 516 may be repeated until the user either actuates Cancel button 444 or OK button 442. If STA system 200 determines at step 512 that the user has actuated OK button 442, the system may determine at step 518 whether or not all of the information that the particular STA request 224 requires has been entered. If the STA request 224 is not complete, at step 520 STA system 200 may notify user, e.g., using a pop-up window, that more information is required. STA system 200 may also be configured to indicate specifically which information is missing.

If at step 518 STA system 200 determines that the STA request 224 is complete, at step 522 the system may query the user as to whether or not the user would like the system to automatically send the request to the respective payer 216. This may be done, e.g., using pop-up window 448 of FIG. 3C. At step 524, STA system 200 may determine whether or not the user desires to confirm sending the STA request 224. If the user does not confirm that the STA request 224 be sent, at step 526 STA system may place the STA request on a worklist for later follow-up or into a batch processing queue 290 for later batch processing. If the user does not want the STA request 224 to be sent, at step 538, STA system 200 may return the user to the original page from which the user entered STA homepage 302.

If at step 524 the user actuated Yes button 450 on pop-up window of FIG. 3C thereby indicated that STA system 200 should send the STA request 224, at step 530 STA system 200 may verify that the payer 216 indicated in the STA request is a valid “trading partner,” i.e., that the health care provider 204 and the particular payer have pre-agreed to communicate STA requests and STA replies 228 to each other electronically. This may be accomplished by STA system 200 performing a lookup to a valid trading partners dictionary 292 in database 268. If at step 530 STA system 200 determines that the appropriate payer 216 is not a valid trading partner, the system may proceed to steps 526 and 528 of placing the STA request 224 on a worklist and returning the use to the original page from which the user entered STA homepage 302.

If at step 530 STA system determines that the payer 216 is a valid trading partner, at steps 532 and 534 the system may, respectively, send the STA request to the respective payer 216 via EDI interface 236 and start a countdown timer 294 and display waiting page 452 of FIG. 3D. At step 536 STA system 200 may determine whether or not an STA reply 228 to the STA request 224 has been received. If not, at step 538 STA system 200 may determine whether or not countdown timer 294 has timed out. If not, automated STA method 500 may enter a loop consisting of steps 536 and 538. If at step 538 countdown timer 294 has timed out, at step 540 STA system 200 may notify the user that the timer has timed out without the system receiving an STA reply 228. STA system 200 may then proceed to steps 526 and 528 in which the system places the STA request on a worklist for follow up and returns the user to the page from which they originally entered STA homepage 302 (FIG. 3A).

If at step 536 STA system 200 determines that a corresponding STA reply 228 has been received from the appropriate payer 216, at step 542 the system may parse the STA reply and translate the codes therein into appropriate descriptors/identifiers using, e.g., rejection reason dictionary 284, rejection action dictionary 286, and pending/not certified dictionary 288, among others. At step 544, STA system 200 may store all of the information in the STA reply 228 in the corresponding patient's medical records in patient records data-store 270 in database 268. At step 546, STA system may display Results page 454 of FIG. 3E so that it contains all of the appropriate descriptors, identifiers, dates, etc. received in the STA reply 228, along with all of the appropriate descriptors, identifiers, dates, etc. of the corresponding STA request 224. Once STA system 200 has displayed Results page 454, the system may determine at steps 548 and 550 whether or not the user has actuated the Cancel button and OK button on the Results page. If the user has actuated the Cancel button, at step 552 STA system may return the user to STA homepage 302. If the user has actuated the OK button, at step 528 STA system 200 may return the user to the page from which they entered STA homepage 302.

If at step 506 the user is not a shell user, but is an experienced/special-knowledge user, at step 554 STA system 200 may receive from the non-shell user a status identifier, via Status field 224 of STA homepage (FIG. 3A), other than “INITIATED,” e.g., “PENDED.” Based on this different status identifier, at step 556 STA system 200 may allow the user to access all forms that the shell user had been restricted from accessing, such as Treatment form 310 of FIG. 3B and Service forms 358-370 of FIGS. 3H-3N. At steps 558 and 560, STA system 200 may poll to determine whether or not the user has actuated either of Cancel button 444 and OK button 442. If the user has actuated Cancel button 444, at step 562 STA system 200 may exit STA homepage 302 and return the user to the page from which they originally accessed the STA homepage. If STA system 200 has determined at step 560 that the user has actuated OK button 442, at step 564 the system may determine whether or not the STA request 224 is complete.

STA system 200 may be configured to determine the completeness of the STA request 224 as a function of the contents of various fields of STA homepage 302, such as Reason field 324, Type field 326, and Insurance field 332. For example, based on the reason and/or type of the STA request 224, STA system 200 may be configured with intelligence about what forms and what fields need to be completed for each reason and/or type. Similarly, STA system 200 may be configured with intelligence that knows that a particular payer 216 requires certain information when other payers may not. If at step 564 STA system determines that the STA request 224 is ready to send, STA method 500 may proceed to step 522 and subsequent steps 524-552 as appropriate and as described above in detail.

However, if at step 564 STA system determines that STA request 224 is not complete, at step 566 the system may receive any input that the non-user enters, e.g., into General form 308 (FIG. 3A) and Treatment form 310 (FIG. 3B). If at step 560 STA system 200 determined that user did not select OK button 442 (FIG. 3A), then STA method 500 may proceed to step 566 just discussed. At step 568, STA system 200 may determine whether or not the user has selected Service button 374. If the use has not selected Service button 374, STA method 500 may return to step 558 and subsequent steps 560-566 and 522-552 as appropriate and as discussed above. If at step 568 STA system 200 has determined that the user has selected Services button 374, at step 570 the system may check the descriptor 372 in Status field 324 of STA homepage (FIG. 3A) for the reason for the STA request 224 and then display the one of Service forms 358-370 (FIGS. 3H-3N), if any, corresponding to that reason.

While displaying the appropriate Service form 358-370, at steps 572, 574 STA system 200 may determine whether or not the user has actuated either of the Cancel and OK buttons appearing on the corresponding Service form. If at step 572 STA system 200 has determined that the user has actuated the Cancel button, STA method 500 may proceed to step 576 at with STA system 200 exits the Service form 358-370 and returns the user to STA homepage 302. If at step 574 STA system 200 determines that the user has not actuated the OK button on the Service form 358-370, at step 578 the system may receive and store any Service form information that the user has to input.

If at step 574 STA system 200 determines that the user has actuated the OK button on the Service form 358-370, at step 580 the system may determined whether or not the STA request 224 is complete, e.g., in the manner discussed above relative to step 564. If at step 580 STA system 200 determines that the STA request 224 is not complete, STA method 500 may proceed to step 582, at which the system notifies the user of the incompleteness of the request, and then to step 576 and steps subsequent to step 576 for further execution as required. If at step 580 STA system has determined that STA request is complete, STA method 500 may proceed to step 522 and subsequent steps 524-552 as appropriate and as described above in detail.

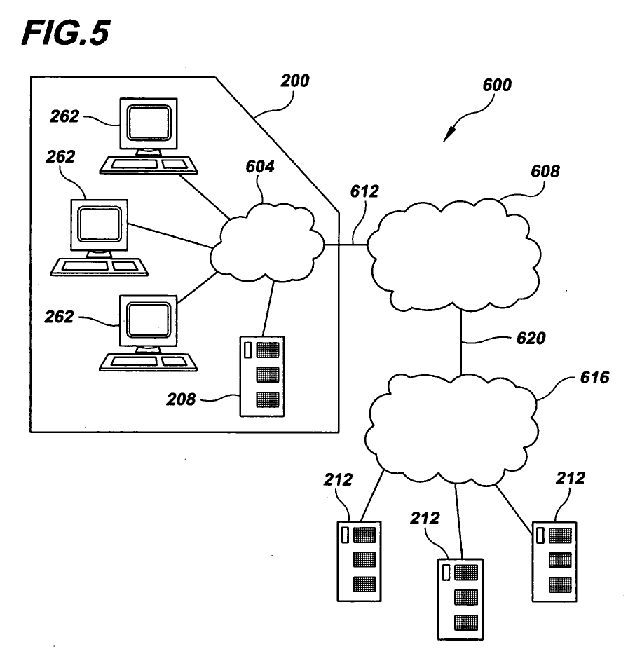

Referring to FIG. 5, and also to FIG. 2, FIG. 5 illustrates a computer system 600 in which an STA system of the present invention, e.g., STA system 200 of FIG. 2, may be implemented. As those skilled in the art will appreciate, an STA system of the present invention may be readily adapted to many other types of computer systems using only knowledge well-known in the art. In the context of STA system 200 of FIG. 2, computer system 600 may include a local area network (LAN) 604, which may be connected to a wide area network (WAN) 608 via link 612, which may in turn be connected to a global network 616, such as the Internet, via link 620. Such links 612, 620 are well-known in the art and, therefore, need not be described in any detail.

Health care provider server 208 may be directly connected to any one of LAN 604, WAN 608, global network 616 or other WAN and/or LAN (not shown) connected to the global network. Likewise, user workstations 262 used to access health care provider server 208 in order to utilize the functionality of STA system 200 may be directly connected to any one of LAN 604, WAN 608, global network 616 or other WAN and/or LAN (not shown) connected to the global network. However, in the present example, health care provider server 208 and workstations 262 are shown as being directly connected to LAN 604. This is typical of a scenario when health care server 208 is on-site relative to all of the users of STA system 200. Also typical, but not necessary, is that payer servers 212, or LANs and/or WANs (not shown) to which payers servers may be directly connected, are connected to global network 616 and not to WAN 608 or LAN 604, although in alternative embodiments one or more of the payer servers or their LANs and/or WANs could be connected to WAN 608 or LAN 604. Regardless of how computer system 600 in configured, the functioning of STA system 200 is essentially the same as described above in connection with FIGS. 2-4, generally with only the communications links, protocols etc. among the various components of the STA system differing to suit the different configurations.

Although the invention has been described and illustrated with respect to an exemplary embodiment thereof, it should be understood by those skilled in the art that the foregoing and various other changes, omissions and additions may be made therein and thereto, without parting from the spirit and scope of the present invention.

What is claimed is:

1. A method of processing a health care service transaction approval request, comprising the steps of:
a) receiving and electronically storing request information required by a health care payer in order to adjudicate a health care service transaction approval request;
b) sending an electronic data interchange (EDI) request to the health care payer, said EDI request containing said request information;
c) receiving an EDI response to said EDI request, said EDI response containing at least one adjudication code;
d) translating said at least one adjudication code into plain text; and
e) displaying on a graphical display a graphical user interface containing said plain text.

2. A method according to claim 1, further comprising the steps of determining a time period between the performance of steps b) and c) and comparing said time period to a predetermined acceptable response time.

3. A method according to claim 1, further comprising the step of presenting to a user a graphical user interface operatively configured to receive at least some of said request information from the user.

4. A method according to claim 3, wherein said at least some of said request information includes one or both of the following: 1) a service type and 2) a service reason, and the method further comprises the steps of:
a) selecting a graphical user interface service form as a function of one or both of said service type and said service reason; and
b) subsequently, displaying said graphical user interface service form to a user.

5. A method according to claim 4, further comprising the steps of:
a) receiving, via said graphical user interface service form, service information; and
b) sending said service information to the health care payer in said EDI request.

6. A method according to claim 1, wherein step d) comprises performing a lookup to a dictionary containing a predetermined set of adjudication codes and a corresponding respective set of plain texts.

7. A method of processing a health care service transaction approval request, comprising the steps of:
a) presenting a graphical user interface to a user, said graphical user interface comprising:
i) a first input receiver operatively configured to indicate a selected health care service type of a predetermined set of health care service types; and
ii) a second input receiver operatively configured to indicate a selected health care service reason of a predetermined set of health care service reasons;
b) receiving via said first input receiver said selected health care service type;
c) receiving via said second input receiver said selected health care service reason; and
d) selecting a health care service form to present to the user as a function of either said selected health care service type received in step b) or said selected health care service reason received in step c) or both of said selected health care service type received in step b) and said selected health care service reason received in step c).

8. A method according to claim 7, further comprising the steps of:
a) generating an electronic data interchange (EDI) request containing one, the other or both of said health care service type and said health care service reason; and
b) sending said EDI request to a health care payer.

9. A method according to claim 8, further comprising the steps of:
a) receiving an EDI response from said health care payer, said EDI response containing at least one adjudication code;
b) translating said at least one adjudication code into plain text; and
c) on a graphical display a graphical user interface containing said plain text.

10. A method according to claim 7, further comprising following step d) the step of displaying on a graphical display a health care service form.

11. A method according to claim 7, wherein step d) comprises performing a lookup to a first dictionary containing said set of predetermined health care service types and a corresponding respective set of first references each corresponding to a respective predetermined health care service form.

12. A method according to claim 7, wherein step d) comprises performing a lookup to a second dictionary containing said set of predetermined health care service reasons and a corresponding respective set of second references each corresponding to a respective predetermined health care service form.

13. A method of processing a health care service transaction approval request, comprising the steps of:
a) presenting a graphical user interface to a user, said graphical user interface comprising an input receiver operatively configured to indicate a specific health care service transaction request status that is a member of a predetermined set of health care service transaction request statuses;
b) receiving via said input receiver said specific health care service transaction request status; and
c) determining whether or not to send a health care service transaction approval request as a function of said specific health care service transaction request status received in step b).

14. A method of processing a health care service transaction approval request, comprising the steps of:
a) presenting a graphical user interface to a user, said graphical user interface comprising a first input receiver operatively configured to indicate a specific health care service transaction request status that is a member of a predetermined set of health care service transaction request statuses;
b) receiving via said first input receiver said specific health care service transaction request status; and
c) determining a number of second input receivers to display to a user as a function of said specific health care service transaction request status received in step b).

15. A computer-readable medium containing computer-executable instructions for performing a method of processing a health care service transaction approval request, said computer-executable instructions comprising:
a) a first set of computer-executable instructions for receiving and electronically storing request information required by a health care payer in order to adjudicate a health care service transaction approval request;
b) a second set of computer-executable instructions for sending an electronic data interchange (EDI) request to said health care payer, said EDI request containing said request information;
c) a third set of computer-executable instructions for receiving an EDI response to said EDI request, said EDI response containing at least one adjudication code;
d) a fourth set of computer-executable instructions for translating said at least one adjudication code into discernable text; and
e) a fifth set of computer-executable instructions for displaying on a graphical display a graphical user interface containing said plain text.

16. A computer-readable medium according to claim 15, further comprising computer-executable instructions for determining a time period between the performance of steps b) and c), and for comparing said time period to a predetermined acceptable response time.

17. A computer-readable medium according to claim 15, further comprising computer-executable instructions for presenting to a user a graphical user interface operatively configured to receive at least some of said request information from the user.

18. A computer-readable medium according to claim 17, wherein said at least some of said request information includes one or both of the following: 1) a service type and 2) a service reason, and the computer-readable medium further comprises:
a) computer-executable instructions for selecting a graphical user interface service form as a function of one or both of said service type and said service reason; and
b) computer-executable instructions for displaying said graphical user interface service form to a user.

19. A computer-readable medium according to claim 18, further comprising:
a) computer-executable instructions for receiving, via said graphical user interface service form, service information; and
b) computer-executable instructions for sending said service information to said health care payer in said EDI request.

20. A computer-readable medium according to claim 15, wherein said fourth set of computer-executable instructions includes computer-executable instructions for performing a lookup to a dictionary containing a predetermined set of adjudication codes and a corresponding respective set of plain texts.

21. A computer-readable medium comprising computer-executable instructions for performing a method of processing a health care service transaction approval request, said computer-executable instructions comprising:
a) a first set of computer-executable instructions for presenting a graphical user interface to a user, said graphical user interface comprising:
i) a first input receiver operatively configured to indicate a selected health care service type of a predetermined set of health care service types; and
ii) a second input receiver operatively configured to indicate a selected health care service reason of a predetermined set of health care service reasons;
b) a second set of computer-executable instructions for receiving via said first input receiver said selected health care service type;
c) a third set of computer-executable instructions for receiving via said second input receiver said selected health care service reason; and
d) a fourth set of computer-executable instructions for selecting a health care service form to present to the user as a function of either said selected health care service type received by said second set of computer-executable instructions or said selected health care service reason received by said third set of computer-executable instructions or both of said selected health care service type received by said second set of computer-executable instructions and said selected health care service reason received by said third set of computer-executable instructions.

22. A computer-readable medium according to claim 21, further comprising:
a) computer-executable instructions for generating an electronic data interchange (EDI) request containing one, the other or both of said health care service type and said health care service reason; and
b) computer-executable instructions for sending said EDI request to a health care payer.

23. A computer-readable medium according to claim 22, further comprising:
a) computer-executable instructions for receiving an EDI response from said health care payer, said EDI response containing at least one adjudication code;
b) computer-readable instructions for translating said at least one adjudication code into plain text; and
c) computer-readable instructions for displaying on a graphical display a graphical user interface containing said plain text.

24. A computer-readable medium according to claim 21, further comprising computer-executable instructions for displaying on a graphical display a health care service form.

25. A computer-readable medium according to claim 21, wherein said fourth set of computer-executable instructions comprises computer-executable instructions for performing a lookup to a first dictionary containing said set of predetermined health care service types and a corresponding respective set of first references each corresponding to a respective predetermined health care service form.

26. A computer-readable medium according to claim 21, wherein said fourth set of computer-executable instructions comprises computer-executable instructions for performing a lookup to a second dictionary containing said set of predetermined health care service reasons and a corresponding respective set of second references each corresponding to a respective predetermined health care service form.

27. A computer-readable medium comprising computer-executable instructions for performing a method of processing a health care service transaction approval request, said computer-executable instructions comprising:
a) a first set of computer-executable instructions for presenting a graphical user interface to a user, said graphical user interface comprising an input receiver operatively configured to indicate a specific health care service transaction request status that is a member of a predetermined set of health care service transaction request statuses;
b) a second set of computer-executable instructions for receiving via said input receiver said specific health care service transaction request status; and
c) a third set of computer-executable instructions for determining whether or not to send a health care service transaction approval request as a function of said specific health care service transaction request status received by said second set of computer-executable instructions.

28. A computer-readable medium comprising computer-executable instructions for performing a method of processing a health care service transaction approval request, said computer-executable instructions comprising:
a) a first set of computer-executable instructions for presenting a graphical user interface to a user, said graphical user interface comprising a first input receiver operatively configured to indicate a specific health care service transaction request status that is a member of a predetermined set of health care service transaction request statuses;
b) a second set of computer-executable instructions for receiving via said first input receiver said specific health care service transaction request status; and
c) a third set of computer-executable instructions for determining a number of second input receivers to display to a user as a function of said specific health care service transaction request status received by said second set of computer-executable instructions.

29. A health care service transaction approval request processing system, comprising:
a) means for receiving and electronically storing request information required by a health care payer in order to adjudicate a health care service transaction approval request;
b) means for sending an electronic data interchange (EDI) request to the health care payer, said EDI request containing said request information;
c) means for receiving an EDI response to said EDI request, said EDI response containing at least one adjudication code;
d) means for translating said at least one adjudication code into plain text; and
e) means for displaying on a graphical display a graphical user interface containing said plain text.

30. A health care service transaction approval request processing system according to claim 29, further comprising means for determining a time period between said sending of said EDI request to the health care payer and said receiving of said EDI response and comparing said time period to a predetermined acceptable response time.

31. A health care service transaction approval request processing system according to claim 29, further comprising means for presenting to a user a graphical user interface operatively configured to receive at least some of said request information from the user.

32. A health care service transaction approval request processing system according to claim 31, wherein said at least some of said request information includes one or both of the following: 1) a service type and 2) a service reason, and the method further comprises:
a) means for selecting a graphical user interface service form as a function of one or both of said service type and said service reason; and
b) means for subsequently displaying said graphical user interface service form to a user.

33. A health care service transaction approval request processing system according to claim 32, further comprising:
a) means for receiving, via said graphical user interface service form, service information; and
b) means for sending said service information to the health care payer in said EDI request.

34. A health care service transaction approval request processing system according to claim 29, wherein said means of clause d) comprises means performing a lookup to a dictionary containing a predetermined set of adjudication codes and a corresponding respective set of plain text.
